(19) United States
(12) Patent Application Publication
(10) Pub. No.: US 2020/0079031 A1
(43) Pub. Date: Mar. 12, 2020

(54) METHOD FOR APPLYING DIECUTS TO SURFACES AND ALSO TEST METHOD THEREFOR

(71) Applicant: tesa SE, Norderstedt (DE)

(72) Inventors: Jannik SELLIN, Hamburg (DE); Arne BARKLEY, Winseldorf (DE); Hans-Peter BRANDT, Schenefeld (DE); Manuel COLLAZO, Pontevedra (ES)

(73) Assignee: tesa SE, Norderstedt (DE)

(21) Appl. No.: 16/567,106

(22) Filed: Sep. 11, 2019

(30) Foreign Application Priority Data
Sep. 11, 2018 (DE) 10 2018 215 412.0
Oct. 25, 2018 (DE) 10 2018 218 283.3

(51) Int. Cl. B29C 65/50; B29C 65/00; C09J 5/00; C09J 7/38; C09J 11/08; C09J 7/26; G01L 5/00

(52) U.S. Cl. CPC B29C 65/5057; B29C 66/9221; B29C 66/9241; B29C 66/863; B29L 2031/30; C09J 7/387; C09J 11/08; C09J 7/26; G01L 5/0033; C09J 5/00

(57) ABSTRACT

Systems and methods transfer diecuts from a liner layer to a surface. One method may transfer a diecut from the liner layer to the surface by means of an applicator, wherein a ratio of the pull-off force of the diecut from the liner layer in the z direction to the pull-off force of the diecut from the surface in the z direction is at most 0.18. The method may enable particularly reliable and firm transfer of the diecut from a diecut tape to a surface where bonding is to take place. As a result, it may be possible for the frequency of errors in the bonding of plastics parts to be relevantly reduced.

This application claims foreign priority benefit under 35 U.S.C. § 119 of German Application Nos. 10 2018 215 412.0 filed Sep. 11, 2018 and 10 2018 218 283.3 filed Oct. 25, 2018.

The present invention relates to a method for transferring diecuts, i.e. die-cut parts, from a liner layer to a surface, the diecuts being transferred from the liner layer to the surface by means of an applicator, characterized in that the ratio of the pull-off force of the diecut from the liner layer in the z direction to the pull-off force of the diecut from the surface in the z direction is at most 0.18. The invention further relates to a test method for the selection of an adhesive tape as diecut tape, the diecut tape being formed of diecuts applied on a liner layer, said diecuts comprising at least one layer of adhesive composition, for the transfer of the diecuts from the liner layer to a surface of a substrate by means of an applicator.

Adhesives and adhesive tapes are generally used for assembling two substrates so as to form a durable or permanent bond. In spite of a multitude of adhesives and adhesive tapes, innovative substrates and also rising requirements in the context of the end application mean that it is necessary to develop new pressure-sensitive adhesives (i.e. self-adhesive compositions), formulations and adhesive-tape designs. It has emerged, for instance, that new components in the interior of motor vehicles, to which adhesive tapes are intended to attach temporarily or permanently, actually have critical surfaces and pose a challenge to adhesive bonding. Because of the low surface energy of these components, there is a need for adhesive tapes specifically developed for these applications.

For the fixing of plastics parts consisting of low-energy materials such as polypropylene, for example, the methods used to date have been mainly welding techniques such as ultrasound, vibration or laser welding, and clips have been used too. These techniques, however, are very inflexible and capital-intensive, but do ensure high instantaneous strengths, and hence continue to be the market standard in the joining technologies for plastics parts.

The use of adhesive tapes is also on the rise because of the ongoing trend within the transport sector, and particularly in the motor vehicle industry, for achieving further reduction in the weight, for example, of a car and so reducing the fuel consumption. As a result, adhesive tapes are being used for applications for which existing adhesive-tape products were not envisaged and developed, and, in addition to the mechanical load and the adhesion substrates which are critical for adhesive applications, there are rising requirements on the UV stability and weathering stability for permanent adhesive bonds in particular.

Consequently there exists a requirement for an adhesive-tape product which is to exhibit improved adhesion on low-energy surfaces such as automotive paints and finishes and at the same time to preserve an outstanding performance profile even under extreme climatic conditions. Low-temperature impact strength and sufficient cohesion even at high temperatures are required by the motor vehicle industry particularly with regard to permanent exterior bonds (badges, bumpers).

The adhesive tape, additionally, is also required to be in line with the production operations. Because of ongoing automation of production operations, and because of the desire for more economical ways of manufacture, the adhesive tape, as soon as it has been positioned at the correct place, must exhibit sufficiently high adhesion and in some cases must also withstand high shearing forces. For these purposes it is an advantage if the adhesive tapes exhibit high tack and if the adhesive compositions flow rapidly onto a variety of substrates, so that effective wetting and hence high peel adhesions are achieved within a very short time.

In the motor vehicle industry, therefore, there is a high demand for double-sided adhesive-tape products that are suitable for the assembly of low-energy surfaces. Single-sided adhesive-tape products as well that exhibit effective adhesion on low-energy surfaces are in demand, for the closing of holes in bodywork parts, for example.

A problem occurring frequently in connection with the production of motor vehicles is that, after work procedures have been carried out, openings made in bodywork parts must be bonded closed again. For example, bodywork parts may be surface-treated with liquid. The liquid needed for the surface treatment runs off by itself via openings made beforehand in the bodywork parts. Subsequently, the openings are closed again. The openings are frequently closed by hand, by diecuts being taken from a diecut tape or diecut sheet and being adhered manually onto the openings. The diecuts have a carrier layer and a layer of adhesive composition applied to one side of the carrier layer. The layer of adhesive composition is in general applied over the full area of the carrier layer.

Also known is the automated application of adhesive tape. One method for this is described for example in DE 100 35 236 A1. In that case, during the application process, adhesive tape is first unwound from a roll and pressed with an application roller onto a surface where bonding is to take place. By means of a further tool, the adhered section of adhesive tape is separated from the rest of the adhesive tape. After that, the application roller is retracted again and the apparatus is moved on to the next bonding site.

Another method for applying double-sided adhesive tape in the motor vehicle industry, and suitable in particular for assembling two curved parts, is described in US 2005/0016671 A1.

For the use of adhesive tapes, economics are a relevant factor. Critically important to this is the application method. To replace weld spots as well, specifically, it is suitable in particular to use diecuts, also referred to as die-cut parts. These are pre-converted sections of adhesive tape. The number and/or size of these diecuts can be adapted to the particular requirement and application. In view of the economics, and in order to ensure a reliable joining operation, automated robotic solutions are especially suitable, in which a robot with an application head is employed.

In this context, in recent times, there has been development of applicators and application methods which also permit the automated application of single-sidedly adhesive diecuts, especially in the sector of the motor vehicle industry. Such applicators and methods are described in the as yet unpublished DE 10 2018 200 439 and DE 10 2018 210 746.

In these methods, a diecut tape with diecuts applied along a retaining belt is moved over a stamp head of a stamp which can be moved forward and backward, with the diecuts having a carrier layer and a layer of adhesive composition, and the carrier layer being disposed between the retaining belt and the layer of adhesive composition. In this arrangement, the diecut tape is stopped when a diecut is positioned over the stamp head, and the stamp is then moved in a forward movement onto the surface, by means of a robot, and the diecut is adhered to the surface. During the forward movement, the diecut tape is repositioned a little, so that the diecut does not slip from the stamp head. Similarly, during the backward movement, the diecut tape is tensioned likewise by repositioning of the diecut tape.

Fundamentally it is critical that the diecuts are applied precisely, rapidly and reliably, even in the case of round-the-clock processing. The precision is influenced decisively by the programming and implementation of robot and applicator. The rapidity and the reliable application of the diecuts correlate definitively not only with robot and applicator but also with the nature of the adhesive tape.

Reliable transfer is to be ensured within a contact pressure time of just a few seconds and with just a low level of contact pressure. A low level of contact pressure must be sufficient, importantly, because otherwise there may be deformation of the component to which the diecut is to be applied.

It is an object of the invention, therefore, to provide a rapid and reliable, i.e. at least economic, application procedure which ensures, in particular in an automated method, that diecuts are transferred reliably and firmly to the substrate where bonding is to take place, including in particular a low-energy substrate, and adhere to it, and do so preferably even where the contact pressure is at just a low level and has just a short duration.

This object is achieved by means of a method as described in the main claim. Dependent claims relate to advantageous developments of the subject matter of the invention. The invention further encompasses the use of the method and also a testing method, i.e. test method, for the suitability of an adhesive tape, and therefore for the selection of an adhesive tape, for the method.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 shows a theoretical side view of an applicator 10, according to one or more examples of the disclosure.

FIG. 2 shows a representation of the dynamic T-block test for determining the pull-off force in the z direction of a diecut from a liner, according to one or more examples of the disclosure.

FIG. 3 shows the dynamic T-block test from FIG. 2 in the individual phases, according to one or more examples of the disclosure.

FIG. 4 shows a representation of a transfer test in the individual phases, according to one or more examples of the disclosure.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Further, as used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

The invention accordingly concerns a method of the type specified above wherein the ratio of pull-off force of the diecut from the liner layer in the z direction to the pull-off force of the diecut from the surface (of a substrate) in the z direction is at most 0.18.

Expressed alternatively:

$$Pull \text{-} off force ratio z direction$$

$$\frac{Pull \text{-} off force z direction from liner [ \frac{N}{{cm}^{2}} ]}{Pull \text{-} off force z direction from substrate [ \frac{N}{{cm}^{2}} ]}$$

The “z direction” here means the direction perpendicular to the areal extent of the diecut.

To the skilled person it is clear that the pull-off force of the diecut from the liner layer pertains to that side of the diecut by way of which the diecut is arranged on the liner layer in the method of the invention. It is also clear to the skilled person that the pull-off force of the diecut from the surface of a substrate pertains to that side of the diecut by way of which the diecut is mounted on the surface of the substrate in the method of the invention.

Surprisingly it has emerged in the context of the invention that reliable and firm transfer, also referred to as “successful dispensing”, is governed not solely by the nature of the surface of the substrate where bonding is to take place, the nature of the adhesive composition or the nature of the liner, but also by the specified ratio of pull-off forces. The pull-off force of the diecut from the surface of a substrate is frequently also dependent on the cleanness of the substrate surface.

In one preferred embodiment of the method, the applicator comprises

(i) a stamp with a stamp head,
(ii) a diecut roll which constitutes a diecut tape which is formed of the diecuts applied to the liner layer, the diecuts comprising at least one layer of (pressure-sensitive) adhesive composition, and
(iii) a liner winding roll,
where, in the method, the diecut tape runs over the stamp head of the stamp, the diecut tape being stopped when one of the diecuts is positioned over the stamp head, and the stamp then adhering the diecut to the surface in an up-and-down movement.

It is particularly favourable if the ratio of pull-off force of the diecut from the liner layer in the z direction to pull-off force of the diecut from the surface in the z direction is at most 0.15, preferably at most 0.12 and more particularly at most 0.10.

The method of the invention is suitable both for manual application of diecuts and for automated application as well. In the particular case of automated application, the method of the invention is accompanied by great advantages, since here there is particularly great importance attached to successful dispensing. Reliable bonding of the diecuts on the surface is particularly important because, in contrast to manual application, where the user sees immediately whether the diecut has been satisfactorily adhered, there is normally no actual direct monitoring of successful dispensing. Moreover, automated application is frequently utilised for the purpose of applying numerous adhesive bonds to a large component, where the error tolerance in the transfer of the individual diecuts is particularly low, since even an individual error leads to erroneous bonding of the large component overall. In the case of the manual bonding of relatively small components using a few diecuts, the error tolerance is comparatively high, since in that case errors can typically be recognised and remedied relatively simply. Successful dispensing rated at 75%, for example, is usually entirely sufficient here, in view of the possibility of direct monitoring by the operative.

The method of the invention is therefore particularly suitable for the automated bonding of diecuts. Advantageously here there is a control system which is signal-conductingly connected to a first sensor, which with a scanning region is directed at the stamp head and registers the presence of one of the diecuts at the stamp head. This may be implemented, for example, by a coloured control mark; however, other recording possibilities are also conceivable. The control system is signal-conductingly connected to the sensor, and sensor measurements are supplied to the control system. The control system is also signal-conductingly connected to a freely movable robotic arm, on which the applicator is disposed. The robotic arm controls, firstly, an up-and-down movement of the applicator in the z direction perpendicularly to the surface, and, secondly, a movement in an xy plane parallel to the surface. The robotic arm is capable of reacting correspondingly to the control signals. The winding roll stops on registration of one of the diecuts at the stamp head, and then drives a down movement of the robotic arm with the applicator for adhering the diecut on the surface, and a subsequent up movement of the robotic arm with the applicator, for return to the original position.

Also controlled, advantageously, is the cycled forward drive of the diecut tape, allowing the subsequent diecut to be positioned on the stamp head. The forward drive of the diecut tape may take the form of a driven first winding roll for the diecut tape. Suitably, after the diecut has been adhered to the surface, the diecut tape is cycled onward by one diecut. In an especially favourable way, the method operates such that the control system actuates the robotic arm and moves the stamp head into a first position over the surface, so that the diecut is adhered in a first surface position, and, after the diecut has been adhered, actuates the robotic arm and moves the stamp head, during the onward cycling of the diecut tape, into a second position over the surface, and there it drives a down movement and a subsequent up movement of the robotic arm with the applicator for the purpose of adhering the next diecut. A method of this kind enables very rapid application of the diecuts to the surface where bonding is to take place.

Often it is desirable to be able to specify the contact pressure very precisely and to be able to ensure that it is observed. Advantageously, therefore, the stamp head is resiliently mounted and the stamp head is assigned at least one pressure sensor which detects the contact pressure force of the diecut on the surface. Thus it can also be ensured that in the case of sensitive components, any deformation thereof is prevented, since a sufficiently low contact pressure can be ensured.

The application tip as well, namely the tip of the applicator, may have different configurations. It may, for example, have a rubberized surface, thereby enabling the applied diecut to conform more effectively to curved contours of the substrate where bonding is to take place.

So that the applicator is brought from the first position to the next position, the control system is preferably programmed with an opening pattern or bonding pattern in the robot control. The control system may for this purpose be designed as an NC controller. It is also conceivable for a second sensor to be provided, registering certain features indicative of the bonding sites as it runs over the surface. A combination of NC controller and a sensor technology may also be provided.

Favourably, the control system actuates the robot, which moves the applicator together with stamp head into a first position over the surface and adheres the diecut at a first surface position. After the diecut has been adhered, the system actuates the robot again and moves the applicator together with stamp head in the xy plane into a second position over the surface; there, the next diecut is adhered to the surface, through a down movement in the z direction, at the next desired site.

Favourably, a diecut roll is provided on a supply side of the stamp head, and the winding roll is provided on a removal side of the stamp head. The winding roll is signal-conductingly connected to the control system, and the liner can be wound up onto it. The control system rotates the winding roll cyclically. The advance of one cycle here corresponds in each case to the distance between adjacent diecuts on the diecut tape.

For improved application, the stamp head may be equipped with a face which is bevelled at 45°, from which diecuts may likewise be applied. This face possesses the same technical control integration means as the horizontal face.

In accordance with the invention, the diecut tape is stopped when a diecut is positioned over the stamp head, the stamp is then moved in a down movement by means of a robotic arm onto the surface, and the diecut is bonded to the surface. During the down movement, the diecut tape is repositioned a little, so that the diecut does not slip from the stamp head. A contact pressure face or at least outer contour of the stamp head is identical to the diecut. Similarly, during the up movement, the diecut tape is tensioned likewise by repositioning of the diecut tape.

Because of the up-and-down movement of the stamp head in the z direction, only very little space is needed in the xy plane in order to apply a diecut to a surface. This is an advantage over the known label dispensers.

The particular feature of the present invention is that it operates for systems of any of a wide variety of different kinds in relation to adhesive composition and liner, provided that they satisfy the pull-off force ratio according to the invention.

The present invention is suitable here both for double-sided adhesive tapes and diecuts which are used to join two parts to one another, and also for single-sided adhesive tapes and diecuts. The latter are employed in the motor vehicle industry, for example, in order to close holes which were necessary as part of the production operation but are not to be visible on the finished product.

The diecut tapes are adhesive tapes. The general expression “adhesive tape” (pressure-sensitive adhesive tape) in the sense of this invention encompasses all sheetlike structures such as two-dimensionally extended films or film sections, tapes with extended length and limited width, tape sections and the like. Diecut tapes are understood to be adhesive tapes wherein the adhesive tape has already been converted beforehand into individual sections.

The adhesive tape therefore has a longitudinal extent (x direction) and a lateral extent (y direction). The adhesive tape also has a thickness (z direction) which runs perpendicularly to the two extents, with the lateral extent and longitudinal extent being greater by a multiple than the thickness. The thickness is very largely the same, preferably exactly the same, over the entire areal extent of the adhesive tape as defined by length and width.

In one preferred embodiment of the present invention, the adhesive tape used in accordance with the invention consists of a single layer of pressure-sensitive adhesive. A single-layer, double-sidedly adhesive tape of this kind, i.e. double-sided adhesive tape, is also referred to as “transfer tape”. In an alternative embodiment, the adhesive tape used in accordance with the invention comprises a carrier layer and at least one, preferably two, layers of pressure-sensitive adhesive composition, and the layers of pressure-sensitive adhesive composition are disposed on the opposing surfaces of the carrier layer and form one outer upper and one outer lower face of the pressure-sensitive adhesive strip. This tape is therefore a single-sided adhesive tape or likewise a double-sided adhesive tape. It is also possible for further layers and/or intermediate liners to be employed. For instance, for the purpose of establishing the properties, the use of different layers of adhesive composition, or a combination of layers of adhesive composition and carrier layers, is also possible. The properties which can be influenced in this way include thickness, stiffness, flexibility, temperature resistance, elasticity and flame retardancy of the adhesive tape. Adhesive tapes suitable and in accordance with the invention therefore encompass single-layer and multi-layer adhesive tapes.

For the purposes of the invention, the term “pressure-sensitive adhesive composition” (PSA) describes materials (for example elastomers) which either are inherently tacky or are formulated by the addition of tackifying resins (“tackifiers”) in such a way that they are tacky. According to the present invention, pressure-sensitive adhesives and/or pressure-sensitive adhesive products encompass materials and/or finished products which, by means of one of the methods in general knowledge for the determination of pressure-sensitive adhesives, are classed as such. This refers in particular to those materials and/or finished products which can be classed as PSAs by one or more of the methods hereinafter. According to a first method, PSAs are defined by the Dahlquist criteria, which are described in D. Satas, Handbook of Pressure Sensitive Adhesives, 2nd Edition, page 172, 1989. According to one of these criteria, a material is defined as a good PSA if at application temperature it has an elasticity modulus of less than 1*10⁶ Pa.

The diecuts of a diecut tape can be designed in all conceivable sizes and shapes, as for example in the form of a solid die-cut part with identical or different edge lengths, round or sharp edges or else specially adapted shapes, but also in the form of a die-cut frame in all conceivable sizes, shapes and land widths. The size of the diecut can be used to adjust the holding force of the individual bonding point. The diecuts may lie directly on the liner, without being covered with a further liner on the other side, and are supplied as such for processing. In this case the component ought to be further processed directly.

It is generally an option to apply diecuts or to bond them to components by means of machine-automated processes. In that case it is possible to remove any liner still present, if required.

Furthermore, the adhesive tape may already have been cut into segments on rolls, as for example for the installation of cabling in the automotive sector. This allows individual pieces to be peeled off from the liner. By contrast with the customary diecuts, the pieces here are adjacent on the liner and hence always rectangular.

Adhesive tapes of the invention that are coated with adhesives on one or both sides are usually wound at the end of the production process to give a roll in the form of an Archimedean spiral. In order to prevent the PSAs coming into contact with one another in the case of double-sidedly adhesive tapes, or in order to ensure easier unrolling in the case of single-sidedly adhesive tapes, the adhesive composition is covered with a covering material (also referred to as release material) before the adhesive tape is wound. The skilled person knows of such covering materials under the name release liners or liners. Besides the covering of single-sidedly or double-sidedly adhesive tapes, liners are also used to enclose labels. A liner (release paper, release film) is not part of a pressure-sensitive adhesive strip, but instead merely an auxiliary for production and/or storage thereof and/or for further processing by die-cuttings. Furthermore, a liner, by contrast with a (permanent) adhesive-tape carrier, is not firmly joined to a layer of adhesive, and hence is also referred to as a temporary carrier. The liners, furthermore, ensure that the adhesive composition is not soiled prior to use. In addition, liners may be formulated, by way of the nature and composition of the release materials, in such a way that the adhesive tape can be unrolled with the desired force (light or heavy). In the case of adhesive tapes coated with adhesive composition on both sides, the liners additionally ensure that the correct side of the adhesive composition is exposed first during unrolling.

Adhesive compositions can be produced in solvent-borne or solvent-free operations, by means of liquid coating, extrusion or other suitable methods. Coating takes place in one or more operations, including coextrusion or multi-layer nozzle coating, or lamination.

In this case either the liner material itself, as such, may already be anti-adhesive, or else it has an anti-adhesive coating—siliconization, for example—on at least one side, preferably both sides. Encompassed in particular are all layers in web form which can be suitably separated from the adhesive tape, including, for example, those having an inherent pressure-sensitive adhesiveness.

Liners used are typically paper or film carriers which are furnished on one side or, in particular, both sides with an abhesive coating composition (also referred to as dehesive or anti-adhesive composition), in order to reduce the tendency for adhering products to adhere to these surfaces (separating function). Liners for self-adhesive tapes are frequently based on biaxially or monoaxially oriented polypropylene, on polyethylene or other polyolefins, on paper or on polyester. A multiplicity of different substances can be used as abhesive coating compositions, which are also called release coatings: waxes, fluorinated or partly fluorinated compounds, carbamate varnishes and, in particular, silicones, and also various copolymers having silicone fractions. In recent years, silicones have become largely established as release materials in the sector of adhesive tape application, owing to their good processing qualities, low costs and broad profile of properties. As liners it is possible, moreover, to use structured liners or liners having fillers or other particular substances or particles in or on the surface, or liners consisting of or coated with other suitable release layers or coatings.

In accordance with the invention there are also carriers which function as a temporary carrier (liner) or else as a permanent carrier (i.e. carrier in the sense of the patent application), according to which side the adhesive layer is applied. Where a carrier has only a single anti-adhesive surface, while the opposite surface is not anti-adhesive (e.g. a single-sidedly siliconized PET carrier), then it functions as a liner when the adhesive layer is applied to the anti-adhesive surface, whereas it functions as a carrier when the adhesive layer is applied to the surface that is not anti-adhesive.

In terms of the adhesive tape, there are various conceivable product constructions. There is always at least one layer of self-adhesive composition. This layer may have a thickness of 15 to 5000 μm, preferably 50 to 3000 μm, more preferably 100 μm to 2000 μm, more preferably still 150 μm to 2000 μm, more preferably still 400 to 1500 μm, more particularly 1000 to 1200 μm, such as, for example, 500 to 800 μm. In the pressure-sensitive adhesive strip there may be further layers, such as further adhesive layers, for example. Furthermore, non-tacky layers, by which are meant, in particular, carrier layers of low extensibility (εₘₐₓ<100%) or which are extensible (εₘₐₓ at least 100%), may be present in the adhesive tape. Any carrier that is present is preferably a carrier film, made of polypropylene, polyethylene or polyester, for example. For strippable pressure-sensitive adhesive tapes, preference is given to using elastic carriers, such as, for example, a viscoelastic acrylate foam, which is foamed using microballoons, for example. Alternatively the acrylate foam may also comprise hollow glass spheres.

An adhesive tape particularly suitable for the method of the invention may comprise, for example, at least one PSA layer which is based on acrylate (co)polymer, silicone (co)polymer, natural rubber, nitrile rubber, i.e. acrylonitrile-butadiene rubber, (optionally chemically or physically crosslinked) synthetic rubber such as vinyl aromatic block copolymer, or a mixture thereof.

Rubbers which can be used by way of example, with or without EBC crosslinking, are described in EP 2832779 A1. They may be, for example, natural rubbers, synthetic rubbers, thermoplastic elastomeric materials, non-thermoplastic elastomeric materials, thermoplastic elastomeric hydrocarbon materials, non-thermoplastic elastomeric hydrocarbon materials, and any desired combinations or mixtures thereof. According to one preferred embodiment, the rubber is selected from the group consisting of halogenated butyl rubbers, especially bromobutyl rubbers such as bromobutyl rubber 2030 from Lanxess (BB2030, bromobutyl rubber having a Mooney viscosity ML (1+8) 125° C. of 32) or bromobutyl rubber X2 from Lanxess (BBX2, bromobutyl rubber having a Mooney viscosity ML (1+8) 125° C. of 46) and chlorobutyl rubbers; halogenated isobutylene-isoprene copolymers; bromoisobutylene-isoprene copolymers; chloroisobutylene-isoprene copolymers; block copolymers; olefinic block copolymers such as Infuse 9807 from Dow (ethylene/octene block copolymer) or Vestoplast751 from Evonik (V751, amorphous polyalphaolefin (ethene-propene-butene copolymer having a softening point of 99° C.); butyl rubbers; synthetic polyisoprenes; ethylene-octylene rubbers; ethylene-propylene rubbers; random ethylene-propylene copolymers; ethylene-propylene-diene monomer rubbers; polyisobutylenes; poly(alpha-olefins); ethylene-α-olefin copolymers; ethylene-α-olefin block copolymers; styrene block copolymers; styrene-isoprene-styrene block copolymers; styrene-butadiene-styrene block copolymers; styrene-ethylene/butadiene-styrene block copolymers; styrene-ethylene/propylene-styrene block copolymers; random styrene-butadiene copolymers; olefinic polymers and copolymers; random ethylene-propylene copolymers; ethylene-propylene-diene terpolymers and any desired combinations or mixtures thereof. According to one preferred embodiment, the rubber is selected from the group consisting of halogenated isobutylene-isoprene copolymers; especially bromoisobutylene-isoprene copolymers, chloroisobutylene-isoprene copolymers; olefinic block copolymers, especially ethylene-octylene block copolymers, ethylene-propylene-butylene copolymers; styrene-isoprene-styrene block copolymers; styrene-butadiene-styrene block copolymers and any desired combinations or mixtures thereof. According to yet a further preferred embodiment, the rubber is selected from the group consisting of halogenated isobutylene-isoprene copolymers; especially bromoisobutylene-isoprene copolymers, chloroisobutylene-isoprene copolymers; olefinic block copolymers, especially ethylene-octylene block copolymers, ethylene-propylene-butylene copolymers, and any desired combinations or mixtures thereof.

In one preferred embodiment, the layer of pressure-sensitive adhesive composition is foamed, in particular with microballoons.

Frequently, moreover, the PSA comprises tackifier resin to adjust the adhesion. It is possible, for example, to use hydrocarbon tackifier resin, in which case the hydrocarbon tackifier resin preferably has a volatile organic compounds (VOC) content of less than 1000 ppm and a volatile fogging compounds (FOG) content of less than 1500 ppm, measured in each case by thermogravimetric analysis. Tackifier resins of this kind are disclosed in EP 2 832 779 A1. Examples of such tackifier resins include Regalite R9100 from Eastman (partially hydrogenated hydrocarbon resin), Regalite R1090 from Eastman (hydrogenated hydrocarbon resin), Piccotac 1020E from Eastman (liquid aliphatic hydrocarbon resin), Plastolyn R1140 from Eastman (hydrogenated hydrocarbon resin), Escorez 1304 from ExxonMobil (aliphatic hydrocarbon resin), Escorez 5615 from ExxonMobil (aliphatic/aromatic hydrocarbon resin), Escorez 5320 from ExxonMobil (hydrogenated cycloaliphatic hydrocarbon resin) and Escorez 5340 from Exxon Mobil (hydrogenated cycloaliphatic hydrocarbon resin).

Moreover, the pressure-sensitive adhesive composition may have been crosslinked by means of UV, electron beams or other radiation, or thermally. Suitable processes based on UV polymerization are also described in DE69214438 T2 or U.S. Pat. No. 7,491,434 B2.

An acrylate PSA is particularly preferred for the adhesive tapes. Preferred alternatively is a PSA based on synthetic rubber such as a vinyl aromatic block copolymer.

Where a PSA based on synthetic rubber is used, it preferably comprises a total of 15 to 50 wt % of synthetic rubber, more preferably in total 20 to 40 wt %, based in each case on the total weight of the PSA. There may be one synthetic rubber or two or more synthetic rubbers present in the PSA of the invention.

The synthetic rubber of the PSA of the invention is preferably a block copolymer having a structure A-B, A-B-A, (A-B)ₙ, (A-B)ₙX or (A-B-A)ₙX, in which
the blocks A independently of one another are a polymer formed by polymerization of at least one vinyl aromatic;
the blocks B independently of one another are a polymer formed by polymerization of conjugated dienes having 4 to 18 carbon atoms and/or isobutylene, or are a partially or fully hydrogenated derivative of such a polymer;
X is the radical of a coupling reagent or initiator and
n is an integer ≥2.

In particular, all synthetic rubbers in the PSA of the invention are block copolymers having a structure as set out above. The PSA of the invention may therefore also comprise mixtures of different block copolymers having a structure as above.

The preferred synthetic rubbers, also referred to as vinyl aromatic block copolymers, therefore comprise one or more rubbery blocks B (soft blocks) and one or more glass-like blocks A (hard blocks). With particular preference the synthetic rubber in the PSA of the invention is a block copolymer having a structure A-B, A-B-A, (A-B)₃X or (A-B)₄X, with A, B and X having the definitions above. Very preferably all the synthetic rubbers in the PSA of the invention are block copolymers having a structure A-B, A-B-A, (A-B)₃X or (A-B)₄X, with A, B and X having the definitions above. More particularly the synthetic rubber in the PSA of the invention is a mixture of block copolymers having a structure A-B, A-B-A, (A-B)₃X or (A-B)₄X, which preferably includes at least diblock copolymers A-B and/or triblock copolymers A-B-A.

The block A is in particular a glassy block having a preferred glass transition temperature (T_{g}) which is above the room temperature. With particular preference the T_{g} of the glassy block is at least 40° C., more particularly at least 60° C., very preferably at least 80° C. and most preferably at least 100° C. The fraction of vinyl aromatic blocks A in the entirety of the block copolymers is preferably 10 to 40 wt %, more preferably 20 to 33 wt %. Vinyl aromatics for constructing the block A include preferably styrene and α-methylstyrene. The block A may therefore take the form of a homopolymer or copolymer. With particular preference the block A is a polystyrene.

The block B is, in particular, a rubbery block or soft block having a preferred Tg of less than room temperature. The T_{g} of the soft block is more preferably less than 0° C., more particularly less than −10° C., as for example less than −40° C. and very preferably less than −60° C.

Preferred conjugated dienes as monomers for the soft block B are selected in particular from the group consisting of butadiene, isoprene, ethylbutadiene, phenylbutadiene, piperylene, pentadiene, hexadiene, ethylhexadiene, dimethylbutadiene and the farnesene isomers, and also any desired mixtures of these monomers. The block B as well may take the form of a homopolymer or a copolymer.

With particular preference the conjugated dienes as monomers for the soft block B are selected from butadiene and isoprene. The soft block B, for example, is a polyisoprene, a polybutadiene or a partly or fully hydrogenated derivative of one of these two polymers, such as, in particular, polybutylene-butadiene; or it is a polymer composed of a mixture of butadiene and isoprene. Very preferably the block B is a polybutadiene. With particular preference, furthermore, the at least one layer of adhesive composition is made of a self-adhesive composition which is based on vinyl aromatic block copolymer and comprises tackifier resin, where the vinyl aromatic block copolymer comprises
at least one polymer block A, formed predominantly by polymerization of vinyl aromatics, and
at the same time at least one polymer block B, formed predominantly by polymerization of conjugated dienes, the fraction of 1,2-linked conjugated diene in the B block being less than 30 wt %, preferably less than 20 wt % (as determinable by means of ¹H-NMR, for example).

In accordance with the invention, the polymer block B of the vinyl aromatic block copolymer is formed predominantly by polymerization of conjugated dienes. This means that the block B has typically been formed from a polymerization wherein more than 50 wt % of the monomers used are conjugated dienes, meaning that the fraction of conjugated diene at polymerization is more than 50 wt %. The polymer block B preferably originates from a polymerization wherein conjugated dienes were used exclusively as monomers.

Furthermore, the fraction of 1,2-linked conjugated diene in the B block is less than 30 wt %, preferably less than 20 wt %, more preferably less than 15 wt % and more particularly about 10 wt %. What is meant by the fraction of 1,2-linked conjugated diene in the B block is the weight fraction of conjugated diene that has been copolymerized by 1,2-addition (in contrast to 1,4-addition), based on the overall monomer composition used in producing the polymer block B. The 1,2-addition of conjugated diene leads to a vinylic side group in the polymer block B, whereas the 1,4-addition of conjugated diene leads to a vinylic functionality in the main chain of the polymer block B. The 1,2-addition of a conjugated diene thus means that the diene functionality is copolymerized either in positions C1 and C2, or at positions C3 and C4 (in the case of isoprene as conjugated diene, for example), as opposed to the 1,4-addition of a conjugated diene, in which the diene functionality is copolymerized at the positions C1 and C4.

The PSA typically comprises, as well as the at least one synthetic rubber such as vinyl aromatic block copolymer, at least one tackifier resin, in order to increase the adhesion in a desired way. The tackifier resin ought to be compatible with the elastomer block (soft block) of the block copolymers. Suitable tackifier resins include preferably unhydrogenated, partially hydrogenated or fully hydrogenated resins based on rosin or rosin derivatives. Ideally this resin is not compatible with the acrylate polymers of the viscoelastic polyacrylate foam carrier. Suitable tackifier resins include preferably hydrogenated polymers of dicyclopentadiene, unhydrogenated, or partially, selectively or fully hydrogenated, hydrocarbon resins based on C5, C5/C9 or C9 monomer streams, or, with particular preference, polyterpene resins based on α-pinene and/or ß-pinene and/or δ-limonene. Aforesaid tackifier resins may be used either alone or in a mixture. Moreover, the adhesive formulation may also include tackifier resins which are liquid at room temperature.

The at least one layer of adhesive composition is preferably foamed, using microballoons, for example. A “foamed PSA layer” is a layer of pressure-sensitive adhesive composition which comprises a pressure-sensitively adhesive matrix material and a plurality of gas-filled cavities, thereby lowering the density of this PSA by comparison with the plane matrix material without cavities. Foaming of self-adhesive compositions, especially by means of microballoons, not only allows savings to be made on costs of raw material, but also leads typically, for example, to an increase in the cohesion of the product, to an improved bond strength on rough substrates, and to heightened shock resistance. Alternatively, the layer of adhesive composition may also be unfoamed.

The matrix material of the PSA layer may in principle be caused to foam in any desired way.

For example, the PSA may be foamed by a propellant gas which is introduced into it or released within it. Introduced propellant gas includes, for example, CO₂ or N₂, possibly in the form of a supercritical fluid.

For the release of a propellant gas, the PSA may alternatively be admixed with a blowing agent which breaks down thermally to release gas, examples being NaHCO₃, the free acids or derivatives of citric acid, ascorbic acid, fumaric acid, gluconic acid or lactic acid, or exothermic blowing agents such as azodicarbonamide.

Also suitable is mechanical foaming (frothing).

In one embodiment the foamed PSA layer comprises at least partially expanded hollow microspheres. These are at least partially expanded microspheres which in their basic state are elastic and expandable and have a thermoplastic polymer shell. These spheres—in the basic state—are filled with low-boiling liquids or liquefied gas. Shell material used is, in particular, polyacrylonitrile, PVDC, PVC or polyacrylates. Common low-boiling liquids are, in particular, hydrocarbons of the low alkanes, as for example isobutane or isopentane, which are enclosed in the form of liquefied gas under pressure in the polymer shell. For microspheres of this kind the term “microballoons” is also customary.

Exposure of the microballoons to heat causes the outer polymer shell to soften. At the same time, the propellant gas in liquid form within the shell undergoes transition to its gaseous state. When this occurs, the microballoons stretch irreversibly and undergo three-dimensional expansion. Expansion is at an end when the internal and external pressures match one another. Since the polymeric shell is retained, the result is a closed-cell foam.

A multiplicity of types of microballoon are available commercially, and differ essentially in their size (6 to 45 μm in diameter in the unexpanded state) and in the onset temperatures they require for expansion (75 to 220° C.). Unexpanded microballoon types are also available in the form of an aqueous dispersion having a solids fraction or microballoon fraction of around 40 to 45 wt %, and additionally in the form of polymer-bound microballoons (masterbatches), for example in ethylene-vinyl acetate with a microballoon concentration of around 65 wt %. Like the unexpanded microballoons, both the microballoon dispersions and the masterbatches are suitable as such for producing the foamed PSA.

A foamed outer PSA layer may also be produced using what are called pre-expanded hollow microspheres. In the case of this group, the expansion takes place prior to the incorporation into the polymer matrix.

With preference in accordance with the invention, the foamed PSA layer, irrespective of its mode of preparation and of the initial form in which the hollow microspheres are used, comprises at least partially expanded hollow microspheres. The term “at least partially expanded hollow microspheres” is understood in accordance with the invention to mean that the hollow microspheres have undergone expansion at least to a degree such as to bring about a reduction in the density of the PSA to a technically meaningful extent by comparison with the same adhesive composition with the unexpanded hollow microspheres. This means that the microballoons need not necessarily have undergone complete expansion. The “at least partially expanded hollow microspheres” have preferably expanded in each case to at least twice their maximum extent in the unexpanded state.

The expression “at least partially expanded” relates to the expanded state of the individual hollow microspheres and is not intended to mean that only some of the hollow microspheres in question must have undergone (initial) expansion. If, therefore, there are “at least partially expanded hollow microspheres”, and unexpanded hollow microspheres present in the PSA, this means that unexpanded (totally unexpanded, in other words having not undergone even initial expansion) hollow microspheres do not belong to the “at least partially expanded hollow microspheres”.

Depending on field of application and desired properties of the PSA of the invention, it may comprise further components and/or additives, and may do so in each case alone or in combination with one or more other additives or components.

Hence the PSA of the invention may for example comprise powderous and granular, including in particular abrasive and reinforcing, fillers, dyes and pigments such as, for example, chalks (CaCO₃), titanium dioxide, zinc oxides and/or carbon blacks.

The PSA of the invention preferably comprises one or more chalks as filler. The PSA of the invention comprises chalk preferably at up to 20 wt % in total. With such proportions there are virtually no changes in significant technical adhesive properties such as the shear strength at room temperature and the instantaneous peel adhesion on steel and PE as a result of the addition of filler. Furthermore, various organic fillers may be included.

Suitable additives for the PSA of the invention are also—chosen independently of other additives—non-expandable hollow polymer spheres, solid polymer spheres, hollow glass spheres, solid glass spheres, hollow ceramic spheres, solid ceramic spheres and/or solid carbon spheres (carbon microballoons).

Furthermore, the PSA of the invention may comprise low-flammability fillers, an example being ammonium polyphosphate; electrically conductive fillers, examples being conductive carbon black, carbon fibres and/or silver-coated beads; thermally conductive materials, examples being boron nitride, aluminium oxide, silicon carbide; ferromagnetic additives, examples being iron(III) oxides; organic renewable raw materials, an example being wood flour; organic and/or inorganic nanoparticles; fibres, compounding agents, ageing inhibitors, light stabilizers and/or ozone protectants.

An exemplary PSA layer and production thereof (hot melt process) in the form of a transfer tape based on vinyl aromatic block copolymer is disclosed below and referred to in the present patent application as adhesive tape K2. The formula is as follows: 25 wt % Kraton D 1101 (styrene-butadiene-styrene triblock copolymer from Kraton Polymers with 16 wt % diblock, block polystyrene content: 31 wt %, fraction of 1,2-linked conjugated diene in the butadiene block: 10 wt %), 25 wt % Kraton D1118 (styrene-butadiene-styrene triblock copolymer from Kraton Polymers with 78 wt % diblock, block polystyrene content: 33 wt %, fraction of 1,2-linked conjugated diene in the butadiene block: 10 wt %), 48 wt % Dercolyte A115 from DRT (solid α-pinene tackifier resin having a ring and ball softening temperature of 115° C. and a DACP of 35° C.), 2 wt % Piccolyte A25 from Pinova (polyterpene resin based on α-pinene with a ring and ball softening temperature of 22 to 28° C.), 3 wt % Expancel 920DU40 from Akzo Nobel (unexpanded microballoons). The sum of the constituents excluding the microballoons adds up to 100 wt %, and the amount of microballoons is based on the sum total of the other constituents. The PSA was produced by means of a hot melt process. The elastomer components were added in the intake of the PRE (planetary roll extruder), which had an intake region and two process sections. The run-in rings had increasing diameter in the process direction. Although different spindle fittings were suitable, preference was given to fittings that were at least % of the maximum fitting number in the first process section. The resin components were melted and added in the second process section of the PRE. A particularly suitable means of producing homogeneous mixtures was a resin split in which one portion of the resin was added in the first process section and the remainder downstream in the second process section. A particularly suitable means of adding the two components was in liquid form via a side feed or run-in rings, in which case the first portion is around 10% of the total amount of resin, and the process was implemented in such a way unless otherwise indicated. Another suitable option would be to add the first resin component in solid form in the intake of the PRE or via the side feed in the first process section. The compounded composition was transferred into the twin-screw extruder via a heated hose. The microballoons were added via a side feed in the first third of the TSE (twin-screw extruder) and foamed there, so that the foaming was substantially at an end before exit from the unit. As a result of heat of friction, the melt temperature in the TSE was always above the wall temperatures set. At the end of the TSE, a vacuum was applied at a suitable point. The melt exit temperature was around 130° C. The melt was then transferred via a preliminary distribution die (coat hanger die) into a two-roll calender, and was shaped between two double-sidedly siliconized 50 μm PET films. This advantageous process always achieved roughnesses Rₐ<5 μm (measured by means of white light interferometry).

Table 1 shows the parameters of the hot melt process.

TABLE 1
Parameters of the hot melt process (L/D = length/diameter).

| Total throughput of elastomer components | 20 | kg/h |
|---|---|---|
| Roll cylinder diameter | 70 | mm |
| PRE central spindle temp. | 50° | C. |
| PRE zone temps | 90° C./90° C./90° C./90° C. | |
| PRE speed | 100/min | |
| Diameter of TSE screws and L/D | 42 mm, 36 L/D | |
| TSE zone temps | 20° C./50° C./80° C./80° C. | |
| TSE speed | 100/min | |
| TSE vacuum | 200 | mbar |

| | |
|---|---|
| Calender roll temps | 120° C./120° C. |

In another preferred embodiment, the adhesive tape from which the diecuts are formed is an adhesive tape with an acrylate-based, viscoelastic foam, to which a PSA layer may have been applied on at least one side, preferably both sides. The applied PSA may be, for example, a PSA based on synthetic rubber such as vinyl aromatic block copolymer (for example as defined above). Alternatively, for example, the PSA may be based on acrylate. This may be defined like the above-described acrylate foam, in which case the acrylate-based PSA may be foamed or unfoamed. The same is true of any adhesive tape of the invention which comprises an acrylate PSA. An acrylate adhesive composition in one embodiment may comprise not only the polyacrylate but also further elastomers such as synthetic rubber, for example.

According to one preferred embodiment, a syntactic foam forms the viscoelastic foam. In the case of a syntactic foam, glass spheres or hollow ceramic spheres (microspheres) or microballoons are incorporated within a polymer matrix. As a result, in the case of a syntactic foam, the cavities are separate from one another and the substances present within the cavities (gas, air) are separated from the surrounding matrix by a membrane. Consequently the material is substantially stronger than conventional foams having unreinforced gas inclusions.

Besides the polyacrylate intended in accordance with the invention, the viscoelastic foams of the adhesive tape of the invention produced by means of the methods of the invention, depicted later on, may comprise all polymers and/or mixtures of polymers that are known to the skilled person. Preferably the foam consists only of polyacrylate as scaffold polymer.

The polyacrylate is preferably obtainable by free or controlled radical polymerization of one or more (meth)acrylic acids or (meth)acrylic esters and with particular preference is crosslinked thermally in order—especially in the case of thick foam layers—to prevent a crosslinking gradient which inevitably results from a photochemical crosslinking process or from electron beam crosslinking.

One preferred variant uses thermally crosslinkable, poly(meth)acrylate-based polymers for the viscoelastic foam. The composition advantageously comprises a polymer consisting of
(a1) 70 to 100 wt % of acrylic esters and/or methacrylic esters and/or the associated free acids, of the following structural formula

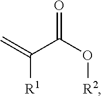

where R¹ represents H or CH₃ and R² represents H or alkyl chains having 1 to 14 carbon atoms;
(a2) 0 to 30 wt % of olefinically unsaturated monomers having functional groups; and
(a3) optionally further acrylates and/or methacrylates and/or olefinically unsaturated monomers (preferably with a fraction between 0 to 5 wt %) which are copolymerizable with component (a1) and have a functional group which by means of the coupling reagent leads to covalent crosslinking.

The weight figures are based on the polymer.

Preference for the monomers (a1) is given to using acrylic monomers comprising acrylic and methacrylic esters with alkyl groups consisting of 1 to 14 carbon atoms. Specific examples, without wishing to be confined by this enumeration, are methyl acrylate, methyl methacrylate, ethyl acrylate, ethyl methacrylate, propyl acrylate, propyl methacrylate, n-butyl acrylate, n-butyl methacrylate, n-pentyl acrylate, n-hexyl acrylate, n-hexyl methacrylate, n-heptyl acrylate, n-octyl acrylate, n-nonyl acrylate, lauryl acrylate, stearyl acrylate, stearyl methacrylate, behenyl acrylate, and branched isomers thereof such as 2-ethylhexyl acrylate, for example.

Further classes of compound for use that may likewise be added in small amounts under (a1) are cyclohexyl methacrylates, isobornyl acrylate and isobornyl methacrylates.

The fraction of these is preferably at most up to 20 wt %, more preferably at most up to 15 wt %, based in each case on the total amount of monomers (a1).

Preference for (a2) is given to using monomers such as, for example, maleic anhydride, itaconic anhydride, glycidyl methacrylate, benzyl acrylate, benzyl methacrylate, phenyl acrylate, phenyl methacrylate, tert-butylphenyl acrylate, tert-butylphenyl methacrylate, phenoxyethyl acrylate, phenoxyethyl methacrylate, 2-butoxyethyl methacrylate, 2-butoxyethyl acrylate, dimethylaminoethyl methacrylate, dimethylaminoethyl acrylate, diethylaminoethyl methacrylate, diethylaminoethyl acrylate and tetrahydrofurfuryl acrylate, this enumeration not being exhaustive.

Likewise used preferably for component (a2) are aromatic vinyl compounds, in which case the aromatic ring systems consist preferably of C4 to C18 building blocks and may also include heteroatoms. Particularly preferred examples are styrene, 4-vinylpyridine, N-vinylphthalimide, methylstyrene and 3,4-dimethoxystyrene, with this enumeration not being exhaustive.

Particularly preferred examples for component (a3) are hydroxyethyl acrylate, 3-hydroxypropyl acrylate, hydroxyethyl methacrylate, 3-hydroxypropyl methacrylate, 4-hydroxybutyl acrylate, 4-hydroxybutyl methacrylate, allyl alcohol, itaconic acid, acrylamide and cyanoethyl methacrylate, cyanoethyl acrylate, 6-hydroxyhexyl methacrylate, N-tert-butylacrylamide, N-methylolmethacrylamide, N-(butoxymethyl)methacrylamide, N-methylolacrylamide, N-(ethoxymethyl)acrylamide, N-isopropylacrylamide, vinylacetic acid, β-acryloyl-oxyproponc acid, trichloroacrylic acid, fumaric acid, crotonic acid, aconitic acid, dimethylacrylic acid and 4-vinylbenzoic acid, this enumeration not being exhaustive.

Monomers of component (a3) may also be selected advantageously such that they contain functional groups which support subsequent chemical radiation crosslinking (by electron beams or UV, for example). Suitable copolymerizable photoinitiators are, for example, benzoin acrylate and acrylate-functionalized benzophenone derivatives. Monomers which support crosslinking by electron bombardment are, for example, tetrahydrofurfuryl acrylate, N-tert-butylacrylamide and allyl acrylate, this enumeration not being exhaustive.

For the polymerization, the monomers are selected such that the resultant polymers can be employed as thermally crosslinkable polyacrylate compositions, more particularly in such a way that the resultant polymers possess properties of pressure-sensitive adherence in line with the “Handbook of Pressure Sensitive Adhesive Technology” by Donatas Satas (van Nostrand, N.Y., 1989).

The PSA used can also be a PSA which as well as polyacrylate also comprises synthetic rubber. Thus, for example, DE 10 2013 215 297 A1 discloses a PSA based on polyacrylate and synthetic rubber and also on a particular tackifier resin, featuring good bonding performance in a temperature range from −30° C. to 70° C., including in particular at room temperature. The PSA comprises (a) 40-70 wt %, based on the total weight of the PSA, of at least one poly(meth)acrylate, (b) 15-50 wt %, based on the total weight of the PSA, of at least one synthetic rubber, and (c) at least one tackifier resin which is compatible with the poly(meth)acrylate(s).

By a “poly(meth)acrylate” is meant a polymer whose monomer basis consists to an extent of at least 60 wt % of acrylic acid, methacrylic acid, acrylic esters and/or methacrylic esters, with acrylic esters and/or methacrylic esters being present at least proportionally, preferably at not less than 50 wt %, based on the overall monomer basis of the polymer in question. In particular a “poly(meth)acrylate” is a polymer obtainable by radical polymerization of acrylic and/or methacrylic monomers and also, optionally, other copolymerizable monomers.

In accordance with the invention the content of (the) poly(meth)acrylate(s) is 40 to 70 wt %, based on the total weight of the PSA. The PSA of the invention preferably comprises 45 to 60 wt %, based on the total weight of the PSA, of at least one poly(meth)acrylate.

The glass transition temperature of the inventively employable poly(meth)acrylates is preferably <0° C., more preferably between −20 and −50° C.

The poly(meth)acrylates of the PSA of the invention are preferably obtainable by at least proportional copolymerization of functional monomers which are preferably crosslinkable with epoxide groups. With particular preference these are monomers having acid groups (particularly carboxylic, sulfonic or phosphonic acid groups) and/or hydroxyl groups and/or acid anhydride groups and/or epoxide groups and/or amine groups; especially preferred are carboxyl-containing monomers. It is especially advantageous if the polyacrylate comprises copolymerized acrylic acid and/or methacrylic acid. All of these groups are crosslinkable with epoxide groups, so making the polyacrylate amenable advantageously to a thermal crosslinking with introduced epoxides.

Further monomers which can be used as comonomers for the poly(meth)acrylates, besides acrylic and/or methacrylic esters having up to 30 carbon atoms per molecule, are, for example, vinyl esters of carboxylic acids containing up to 20 carbon atoms, vinyl aromatics having up to 20 carbon atoms, ethylenically unsaturated nitriles, vinyl halides, vinyl ethers of alcohols containing 1 to 10 carbon atoms, aliphatic hydrocarbons having 2 to 8 carbon atoms and one or two double bonds, or mixtures of these monomers.

The properties of the poly(meth)acrylate in question may be influenced in particular by varying the glass transition temperature of the polymer, by means of different weight proportions of the individual monomers. The poly(meth)acrylate(s) of the invention may preferably be traced back to the following monomer composition:

a) acrylic esters and/or methacrylic esters of the following formula

CH₂═C(R^{I})(COOR^{II})

where R^{I} is H or CH₃ and R^{II} is an alkyl radical having 4 to 14 carbon atoms,
b) olefinically unsaturated monomers having functional groups of the kind already defined for reactivity with preferably epoxide groups,
c) optionally further acrylates and/or methacrylates and/or olefinically unsaturated monomers which are copolymerizable with component (a).

The proportions of the corresponding components (a), (b) and (c) are preferably selected such that the polymerization product has a glass transition temperature of <0° C., more preferably between −20 and −50° C. It is particularly advantageous to select the monomers of component (a) with a proportion of 45 to 99 wt %, the monomers of component (b) with a proportion of 1 to 15 wt % and the monomers of component (c) with a proportion of 0 to 40 wt % (the figures are based on the monomer mixture for the “base polymer”, i.e., without additions of possible additives to the completed polymer, such as resins etc.).

The monomers of component (a) are, in particular, plasticizing and/or apolar monomers. Preferred for use as monomers (a) are acrylic and methacrylic esters having alkyl groups consisting of 4 to 14 carbon atoms, more preferably 4 to 9 carbon atoms. Examples of such monomers are n-butyl acrylate, n-butyl methacrylate, n-pentyl acrylate, n-pentyl methacrylate, n-amyl acrylate, n-hexyl acrylate, n-hexyl methacrylate, n-heptyl acrylate, n-octyl acrylate, n-octyl methacrylate, n-nonyl acrylate and the branched isomers thereof such as, for example, isobutyl acrylate, isooctyl acrylate, isooctyl methacrylate, 2-ethylhexyl acrylate or 2-ethylhexyl methacrylate.

The monomers of component (b) are, in particular, olefinically unsaturated monomers having functional groups, especially having functional groups which are able to enter into a reaction with epoxide groups.

For component (b) it is preferred to use monomers having functional groups selected from the group encompassing the following: hydroxyl, carboxyl, sulfonic acid or phosphonic acid groups, acid anhydrides, epoxides, amines.

Particularly preferred examples of monomers of component (b) are acrylic acid, methacrylic acid, itaconic acid, maleic acid, fumaric acid, crotonic acid, aconitic acid, dimethylacrylic acid, β-acryloyloxypropionic acid, trichloroacrylic acid, vinylacetic acid, vinylphosphonic acid, maleic anhydride, hydroxyethyl acrylate, especially 2-hydroxyethyl acrylate, hydroxypropyl acrylate, especially 3-hydroxypropyl acrylate, hydroxybutyl acrylate, especially 4-hydroxybutyl acrylate, hydroxyhexyl acrylate, especially 6-hydroxyhexyl acrylate, hydroxyethyl methacrylate, especially 2-hydroxyethyl methacrylate, hydroxypropyl methacrylate, especially 3-hydroxypropyl methacrylate, hydroxybutyl methacrylate, especially 4-hydroxybutyl methacrylate, hydroxyhexyl methacrylate, especially 6-hydroxyhexyl methacrylate, allyl alcohol, glycidyl acrylate, glycidyl methacrylate.

In principle as component (c) it is possible to use all vinylically functionalized compounds which are copolymerizable with component (a) and/or with component (b). The monomers of component (c) may serve to adjust the properties of the resultant PSA.

Exemplary monomers of component (c) are as follows:

methyl acrylate, ethyl acrylate, propyl acrylate, methyl methacrylate, ethyl methacrylate, benzyl acrylate, benzyl methacrylate, sec-butyl acrylate, tert-butyl acrylate, phenyl acrylate, phenyl methacrylate, isobornyl acrylate, isobornyl methacrylate, tert-butylphenyl acrylate, tert-butylphenyl methacrylate, dodecyl methacrylate, isodecyl acrylate, lauryl acrylate, n-undecyl acrylate, stearyl acrylate, tridecyl acrylate, behenyl acrylate, cyclohexyl methacrylate, cyclopentyl methacrylate, phenoxyethyl acrylate, phenoxyethyl methacrylate, 2-butoxyethyl methacrylate, 2-butoxyethyl acrylate, 3,3,5-trimethylcyclohexyl acrylate, 3,5-dimethyladamantyl acrylate, 4-cumylphenyl methacrylate, cyanoethyl acrylate, cyanoethyl methacrylate, 4-biphenyl acrylate, 4-biphenyl methacrylate, 2-naphthyl acrylate, 2-naphthyl methacrylate, tetrahydrofurfuryl acrylate, diethylaminoethyl acrylate, diethylaminoethyl methacrylate, dimethylaminoethyl acrylate, dimethylaminoethyl methacrylate, 2-butoxyethyl acrylate, 2-butoxyethyl methacrylate, methyl 3-methoxyacrylate, 3-methoxybutyl acrylate, phenoxyethyl acrylate, phenoxyethyl methacrylate, 2-phenoxyethyl methacrylate, butyl diglycol methacrylate, ethylene glycol acrylate, ethylene glycol monomethyl acrylate, methoxy polyethylene glycol methacrylate 350, methoxy polyethylene glycol methacrylate 500, propylene glycol monomethacrylate, butoxydiethylene glycol methacrylate, ethoxytriethylene glycol methacrylate, octafluoropentyl acrylate, octafluoropentyl methacrylate, 2,2,2-trifluoroethyl methacrylate, 1,1,1,3,3,3-hexafluoroisopropyl acrylate, 1,1,1,3,3,3-hexafluoroisopropyl methacrylate, 2,2,3,3,3-pentafluoropropyl methacrylate, 2,2,3,4,4,4-hexafluorobutyl methacrylate, 2,2,3,3,4,4,4-heptafluorobutyl acrylate, 2,2,3,3,4,4,4-heptafluorobutyl methacrylate, 2,2,3,3,4,4,5,5,6,6,7,7,8,8,8-pentadecafluorooctyl methacrylate, dimethylaminopropylacrylamide, dimethylaminopropylmethacrylamide, N-(1-methyl-undecyl)acrylamide, N-(n-butoxymethyl)acrylamide, N-(butoxymethyl)methacrylamide, N-(ethoxymethyl)acrylamide, N-(n-octadecyl)acrylamide, additionally N,N-dialkyl-substituted amides, such as, for example, N,N-dimethylacrylamide, N,N-dimethylmethacrylamide, N-benzylacrylamides, N-isopropylacrylamide, N-tert-butylacrylamide, N-tert-octylacrylamide, N-methylolacrylamide, N-methylolmethacrylamide, acrylonitrile, methacrylonitrile, vinyl ethers, such as vinyl methyl ether, ethyl vinyl ether, vinyl isobutyl ether, vinyl esters, such as vinyl acetate, vinyl chloride, vinyl halides, vinylidene chloride, vinylidene halides, vinylpyridine, 4-vinylpyridine, N-vinylphthalimide, N-vinyllactam, N-vinylpyrrolidone, styrene, α- and p-methylstyrene, α-butylstyrene, 4-n-butylstyrene, 4-n-decylstyrene, 3,4-dimethoxystyrene. Macromonomers such as 2-polystyrene-ethyl methacrylate (weight-average molecular weight M_{w} of 4000 to 13 000 g/mol), poly(methyl methacrylate)-ethyl methacrylate (M_{w} of 2000 to 8000 g/mol).

Monomers of component (c) may advantageously also be chosen such that they contain functional groups which support subsequent radiation crosslinking (by electron beams or UV, for example). Suitable copolymerizable photoinitiators are, for example, benzoin acrylate and acrylate-functionalized benzophenone derivatives. Monomers which support crosslinking by electron bombardment are, for example, tetrahydrofurfuryl acrylate, N-tert-butylacrylamide and allyl acrylate.

The preparation of the polyacrylates (“polyacrylates” is understood in the context of the invention to be synonymous with “poly(meth)acrylates”) may take place by methods familiar to the skilled person, especially advantageously by conventional radical polymerizations or controlled radical polymerizations. The polyacrylates can be prepared by copolymerization of the monomeric components using the customary polymerization initiators and also, optionally, using chain transfer agents, with polymerization taking place at the usual temperatures in bulk, in emulsion, for example in water or liquid hydrocarbons, or in solution.

The polyacrylates are preferably prepared by polymerization of the monomers in solvents, more particularly in solvents having a boiling range of 50 to 150° C., preferably of 60 to 120° C., using the customary amounts of polymerization initiators, which are in general 0.01 to 5 wt %, more particularly 0.1 to 2 wt % (based on the total weight of the monomers).

Suitable in principle are all customary initiators familiar to the skilled person. Examples of radical sources are peroxides, hydroperoxides and azo compounds, as for example dibenzoyl peroxide, cumene hydroperoxide, cyclohexanone peroxide, di-t-butyl peroxide, cyclohexylsulfonyl acetyl peroxide, diisopropyl percarbonate, t-butyl peroctoate, benzopinacol. One very preferred procedure uses 2,2′-azobis(2-methylbutyronitrile) (Vazo® 67™ from DuPont) or 2,2′-azobis(2-methylpropionitrile) (2,2′-azobisisobutyronitrile; AIBN; Vazo® 64™ from DuPont) as radical initiator.

Solvents suitable for preparing the poly(meth)acrylates include alcohols such as methanol, ethanol, n- and isopropanol, n- and isobutanol, preferably isopropanol and/or isobutanol, and also hydrocarbons such as toluene and, in particular, benzines of a boiling range from 60 to 120° C. Additionally it is possible to use ketones such as preferably acetone, methyl ethyl ketone, methyl isobutyl ketone, and esters such as ethyl acetate, and also mixtures of solvents of the type stated, preference being given to mixtures which include isopropanol, more particularly in amounts of 2 to 15 wt %, preferably 3 to 10 wt %, based on the solvent mixture used.

With preference, after the preparation (polymerization) of the polyacrylates, there is a concentration process, and the further processing of the polyacrylates is substantially solvent-free. The polymer can be concentrated in the absence of crosslinker and accelerator substances. It is also possible, however, for one of these classes of compound to be added to the polymer even prior to concentration, in which case the concentration takes place in the presence of this or these substance(s).

After the concentration step, the polymers can be transferred to a compounder. Concentration and compounding may optionally also take place in the same reactor.

The weight-average molecular weights M_{w} of the polyacrylates are preferably in a range from 20 000 to 2 000 000 g/mol, very preferably in a range from 100 000 to 1 500 000 g/mol, most preferably in a range from 150 000 to 1 000 000 g/mol. It may be advantageous to carry out polymerization in the presence of suitable chain transfer agents such as thiols, halogen compounds and/or alcohols in order to set the desired average molecular weight.

The figures for the weight-average molecular weight M_{w}, the number-average molecular weight Mₙ and the polydispersity PD in this specification relate to the determination by gel permeation chromatography (GPC). The determination is made on 100 μl of a sample having undergone clarifying filtration (sample concentration 4 g/I). The eluent used is tetrahydrofuran with 0.1 vol % of trifluoroacetic acid. Measurement takes place at 25° C. The precolumn used is a column of type PSS-SDV, 5 μm, 10³ Å, 8.0 mm*50 mm (details here and hereinafter in the following order: type, particle size, porosity, internal diameter*length; 1 Å=10⁻¹⁰ m). For separation a combination of the columns of type PSS-SDV, 5 μm, 10³ Å and also 10⁵ Å and 10⁶ Å each with 8.0 mm*300 mm is used (columns from Polymer Standards Service; detection by means of Shodex R171 differential refractometer). The flow rate is 1.0 ml per minute. Calibration takes place against PMMA standards (polymethyl methacrylate calibration) in the case of polyacrylates and against PS standards (polystyrene calibration) otherwise (resins, elastomers).

The polyacrylates preferably have a K value of 30 to 90, more preferably of 40 to 70, as measured in toluene (1% strength solution, 21° C.). The K value of Fikentscher is a measure of the molecular weight and the viscosity of the polymer. The principle of the method is based on the determination of the relative solution viscosity by capillary viscosimetry. For this purpose the substance under test is dissolved in toluene by shaking for thirty minutes to give a 1% strength solution. In a Vogel-Ossag viscosimeter at 25° C., the flow time is measured and is used to determine the relative viscosity of the sample solution in relation to the viscosity of the pure solvent. From tables it is possible according to Fikentscher [P. E. Hinkamp, Polymer, 1967, 8, 381] to read off the K value (K=1000 k).

Especially suitable in accordance with the invention are polyacrylates which have a narrow molecular weight distribution (polydispersity PD<4). In spite of a relatively low molecular weight, these compositions have a particularly good shear strength after crosslinking. Moreover, the lower polydispersity makes processing from the melt easier, since the flow viscosity is lower than that of a more broadly distributed polyacrylate, for largely the same application properties. Narrowly distributed poly(meth)acrylates may be prepared advantageously by anionic polymerization or by controlled radical polymerization methods, the latter being especially suitable. Via N-oxyls as well it is possible to prepare corresponding polyacrylates. Furthermore, Atom Transfer Radical Polymerization (ATRP) may be used advantageously for the synthesis of narrowly distributed polyacrylates, in which case the initiator used preferably comprises monofunctional or difunctional secondary or tertiary halides, with the halide or halides being abstracted using Cu, Ni, Fe, Pd, Pt, Ru, Os, Rh, Co, Ir, Ag or Au complexes.

The monomers for preparing the poly(meth)acrylates preferably proportionally contain functional groups suitable for entering into linking reactions with epoxide groups. This has the advantageous effect of allowing the polyacrylates to be crosslinked thermally by reaction with epoxides. Linking reactions are, in particular, addition reactions and substitution reactions. Preferably, therefore, there is a linking of the building blocks carrying the functional groups to building blocks carrying epoxide groups, especially in the sense of a crosslinking of the polymer units carrying the functional groups, via crosslinker molecules carrying epoxide groups, as linking bridges. The substances containing epoxide groups are preferably polyfunctional epoxides, these being those having at least two epoxide groups; accordingly, there is preferably in total an indirect linking of the building blocks carrying the functional groups.

The poly(meth)acrylates of the PSA of the invention are crosslinked preferably by linking reactions—especially in the sense of addition or substitution reactions—of the functional groups they contain with thermal crosslinkers. All thermal crosslinkers can be used that both ensure a sufficiently long processing time, so that there is no gelling during the processing operation, especially the extrusion operation, and also lead to rapid post-crosslinking of the polymer to the desired degree of crosslinking at temperatures lower than the processing temperature, especially at room temperature. Possible for example is a combination of polymers containing carboxyl, amine and/or hydroxyl groups with isocyanates, especially aliphatic or amine-deactivated trimerized isocyanates, as crosslinkers.

Suitable isocyanates are especially trimerized derivatives of MDI [4,4-methylenedi(phenyl isocyanate)], HDI [hexamethylene diisocyanate, 1,6-hexylene diisocyanate] and/or IPDI [isophorone diisocyanate, 5-isocyanato-1-isocyanatomethyl-1,3,3-trimethylcyclohexane], examples being the products Desmodur® N3600 and XP2410 (each BAYER AG: aliphatic polyisocyanates, low-viscosity HDI trimers). Likewise suitable is the surface-deactivated dispersion of micronized trimerized IPDI BUEJ 339®, now HF9 ® (BAYER AG).

Also suitable in principle for the crosslinking, however, are other isocyanates such as Desmodur VL 50 (MDI-based polyisocyanates, Bayer AG), Basonat F200WD (aliphatic polyisocyanate, BASF AG), Basonat HW100 (water-emulsifiable, polyfunctional, HDI-based isocyanate, BASF AG), Basonat HA 300 (allophanate-modified polyisocyanate based on isocyanurate, HDI-based, BASF) or Bayhydur VPLS2150/1 (hydrophilically modified IPDI, Bayer AG).

Preferred for use are thermal crosslinkers at 0.1 to 5 wt %, more particularly at 0.2 to 1 wt %, based on the total amount of the polymer to be crosslinked.

The poly(meth)acrylates of the PSA of the invention are crosslinked preferably by means of epoxide(s) or by means of one or more substances containing epoxide groups. The substances containing epoxide groups are, in particular, polyfunctional epoxides, i.e., those having at least two epoxide groups; accordingly, the overall effect is that of indirect linking of those building blocks in the poly(meth)acrylates that carry the functional groups. The substances containing epoxide groups may be both aromatic and aliphatic compounds.

Outstandingly suitable polyfunctional epoxides are oligomers of epichlorohydrin, epoxy ethers of polyhydric alcohols (especially ethylene, propylene and butylene glycols, polyglycols, thiodiglycols, glycerol, pentaerythritol, sorbitol, polyvinyl alcohol, polyallyl alcohol and the like), epoxy ethers of polyhydric phenols [especially resorcinol, hydroquinone, bis(4-hydroxyphenyl)methane, bis(4-hydroxy-3-methylphenyl)methane, bis(4-hydroxy-3,5-dibromophenyl)methane, bis(4-hydroxy-3,5-difluorophenyl)methane, 1,1-bis(4-hydroxyphenyl)ethane, 2,2-bis(4-hydroxyphenyl)propane, 2,2-bis(4-hydroxy-3-methylphenyl)propane, 2,2-bis(4-hydroxy-3-chlorophenyl)propane, 2,2-bis(4-hydroxy-3,5-dichlorophenyl)propane, 2,2-bis(4-hydroxy-3,5-dichlorophenyl)propane, bis(4-hydroxyphenyl)phenylmethane, bis(4-hydroxyphenyl)phenylmethane, bis(4-hydroxyphenyl)diphenylmethane, bis(4-hydroxyphenyl)-4′-methylphenylmethane, 1,1-bis(4-hydroxyphenyl)-2,2,2-trichloroethane, bis(4-hydroxyphenyl)-(4-chlorophenyl)methane, 1,1-bis(4-hydroxyphenyl)cyclohexane, bis(4-hydroxyphenyl)cyclohexylmethane, 4,4′-dihydroxybiphenyl, 2,2′-dihydroxybiphenyl, 4,4′-dihydroxydiphenyl sulfone] and also their hydroxyethyl ethers, phenol-formaldehyde condensation products, such as phenol alcohols, phenol-aldehyde resins and the like, S- and N-containing epoxides (for example, N,N-diglycidylaniline, N,N′-dimethyldiglycidyl-4,4-diaminodiphenylmethane), and also epoxides prepared by customary methods from polyunsaturated carboxylic acids or monounsaturated carboxylic acid residues of unsaturated alcohols, glycidyl esters, polyglycidyl esters, which may be obtained by polymerization or copolymerization of glycidyl esters of unsaturated acids, or are obtainable from other acidic compounds (cyanuric acid, diglycidyl sulfide, cyclic trimethylene trisulfone or derivatives thereof, and others).

Very suitable ethers are, for example, 1,4-butanediol diglycidyl ether, polyglycerol-3-glycidyl ether, cyclohexanedimethanol diglycidyl ether, glycerol triglycidyl ether, neopentyl glycol diglycidyl ether, pentaerythritol tetraglycidyl ether, 1,6-hexanediol diglycidyl ether), polypropylene glycol diglycidyl ether, trimethylolpropane triglycidyl ether, pentaerythritol tetraglycidyl ether, bisphenol A diglycidyl ether and bisphenol F diglycidyl ether.

Particularly preferred for the poly(meth)acrylates as polymers to be crosslinked is the use of a crosslinker-accelerator system (“crosslinking system”), described for example in EP 1 978 069 A1, in order to obtain better control over both the processing time, crosslinking kinetics, and also the degree of crosslinking. The crosslinker-accelerator system comprises at least one substance containing epoxide groups, as crosslinker, and as accelerator at least one substance which has accelerating effect for crosslinking reactions by means of compounds containing epoxide groups, at a temperature below the melting temperature of the polymer to be crosslinked.

Accelerators used in accordance with the invention are more preferably amines (formally regarded as substitution products of ammonia; in the formulae below, said substituents are represented by “R” and in particular comprise alkyl and/or aryl radicals and/or other organic radicals), with more particular preference those amines which enter into no reactions or only minor reactions with the building blocks of the polymers that are to be crosslinked.

In principle, accelerators that can be selected are primary (NRH₂), secondary (NR₂H) or else tertiary (NR₃) amines, and of course also those having two or more primary and/or secondary and/or tertiary amine groups. Particularly preferred accelerators, however, are tertiary amines such as, for example, triethylamine, triethylenediamine, benzyldimethylamine, dimethylaminomethylphenol, 2,4,6-tris(N,N-dimethylaminomethyl)phenol, N,N′-bis(3-(dimethylamino)propyl)urea. Accelerators which can be used advantageously are also polyfunctional amines such as diamines, triamines and/or tetramines. Outstandingly suitable for example are diethylenetriamine, triethylenetetramine, trimethylhexamethylenediamine.

Further used as accelerators are preferably amino alcohols. Particular preference is given to using secondary and/or tertiary amino alcohols, and, in the case of two or more amine functionalities per molecule, preferably at least one, preferably all, of the amine functionalities are secondary and/or tertiary. As preferred amino alcohol accelerators it is possible to use triethanolamine, N,N-bis(2-hydroxypropyl)ethanolamine, N-methyldiethanolamine, N-ethyldiethanolamine, 2-aminocyclohexanol, bis(2-hydroxycyclohexyl)methylamine, 2-(diisopropylamino)ethanol, 2-(dibutylamino)ethanol, N-butyldiethanolamine, N-butylethanolamine, 2-[bis(2-hydroxyethyl)amino]-2-(hydroxymethyl)-1,3-propanediol, 1-[bis(2-hydroxyeth-yl)amino]-2-propanol, triisopropanolamine, 2-(dimethylamino)ethanol, 2-(diethyl-amino)ethanol, 2-(2-dimethylaminoethoxy)ethanol, N,N,N′-trimethyl-N′-hydroxyethyl bisaminoethyl ether, N,N,N′-trimethylaminoethylethanolamine and/or N,N,N′-trimethyl-aminopropylethanolamine. Further suitable accelerators are pyridine, imidazoles (such as, for example, 2-methylimidazole) and 1,8-diazabicyclo[5.4.0]undec-7-ene. Cycloaliphatic polyamines as well can be used as accelerators. Also suitable are phosphate-based accelerators such as phosphines and/or phosphonium compounds, such as, for example, triphenylphosphine or tetraphenylphosphonium tetraphenylborate.

The PSA of the invention further comprises at least one synthetic rubber. In accordance with the invention the synthetic rubber or rubbers are present in the PSA at 15 to 50 wt %, based on the total weight of the PSA. The PSA preferably comprises 20 to 40 wt % of at least one synthetic rubber, based on the total weight of the PSA.

Preferably at least one synthetic rubber in the PSA of the invention is a block copolymer having an A-B, A-B-A, (A-B)ₙ, (A-B)ₙX or (A-B-A)ₙX construction, in which
the blocks A independently of one another are a polymer formed by polymerization of at least one vinyl aromatic;
the blocks B independently of one another are a polymer formed by polymerization of conjugated dienes having 4 to 18 carbon atoms and/or isobutylene, or are a partly or fully hydrogenated derivative of such a polymer;
X is the residue of a coupling reagent or initiator; and
n is an integer ≥2.

In particular all synthetic rubbers in the PSA of the invention are block copolymers having a construction as set out above. The PSA of the invention may therefore also comprise mixtures of different block copolymers having a construction as above.

Suitable block copolymers (vinyl aromatic block copolymers) thus comprise one or more rubberlike blocks B (soft blocks) and one or more glasslike blocks A (hard blocks). More preferably at least one synthetic rubber in the PSA of the invention is a block copolymer having an A-B, A-B-A, (A-B)₃X or (A-B)₄X construction, where A, B and X are as defined above. Very preferably all synthetic rubbers in the PSA of the invention are block copolymers having an A-B, A-B-A, (A-B)₃X or (A-B)₄X construction, where A, B and X are as defined above. More particularly the synthetic rubber in the PSA of the invention is a mixture of block copolymers having an A-B, A-B-A, (A-B)₃X or (A-B)₄X construction which preferably comprises at least diblock copolymers A-B and/or triblock copolymers A-B-A.

Block A is generally a glasslike block having a preferred glass transition temperature (T_{g}) which is above room temperature. More preferably the T_{g} of the glasslike block is at least 40° C., more particularly at least 60° C., very preferably at least 80° C. and most preferably at least 100° C. The proportion of vinyl aromatic blocks A in the overall block copolymers is preferably 10 to 40 wt %, more preferably 20 to 33 wt %. Vinyl aromatics for the construction of block A include preferably styrene, α-methylstyrene and/or other styrene derivatives. Block A may therefore be a homopolymer or copolymer. More preferably block A is a polystyrene.

The vinyl aromatic block copolymer additionally generally has a rubberlike block B or soft block having a preferred T_{g} of less than room temperature. The T_{g} of the soft block is more preferably less than 0° C., more particularly less than −10° C., as for example less than −40° C., and very preferably less than −60° C.

Preferred conjugated dienes as monomers for the soft block B are, in particular, selected from the group consisting of butadiene, isoprene, ethylbutadiene, phenylbutadiene, piperylene, pentadiene, hexadiene, ethylhexadiene, dimethylbutadiene and the farnesene isomers, and also any desired mixtures of these monomers. Block B as well may be a homopolymer or copolymer.

The conjugated dienes as monomers for the soft block B are more preferably selected from butadiene and isoprene. For example, the soft block B is a polyisoprene, a polybutadiene or a partly or fully hydrogenated derivative of one of these two polymers, such as polybutylenebutadiene in particular; or a polymer of a mixture of butadiene and isoprene. Very preferably the block B is a polybutadiene.

The PSA of the invention further comprises at least one tackifier which is compatible with the poly(meth)acrylate(s) and may also be referred to as peel adhesion booster or tackifying resin. A “tackifier” in line with the general understanding of the skilled person is an oligomeric or polymeric resin which raises the autoadhesion (the tack, the inherent stickiness) of the PSA in comparison to the otherwise identical PSA containing no tackifier.

A “tackifier compatible with the poly(meth)acrylate(s)” is a tackifier which alters the glass transition temperature of the system obtained after thorough mixing of poly(meth)acrylate and tackifier, in comparison to the pure poly(meth)acrylate, where even the mixture of poly(meth)acrylate and tackifier can only be assigned one Tg. In the system obtained after thorough mixing of poly(meth)acrylate and tackifier, a tackifier not compatible with the poly(meth)acrylate(s) would lead to two Tgs, one of them assignable to the poly(meth)acrylate and the other to the resin domains. The determination of the Tg in this context takes place calorimetrically by DSC (differential scanning calorimetry).

The poly(meth)acrylate-compatible resins in the composition of the invention preferably have a DACP of less than 0° C., very preferably of at most −20° C., and/or preferably an MMAP of less than 40° C., very preferably of at most 20° C. Regarding the determination of DACP and MMAP, reference is made to C. Donker, PSTC Annual Technical Seminar, Proceedings, pp. 149-164, May 2001.

In accordance with the invention the tackifier compatible with the poly(meth)acrylates is preferably a terpene-phenolic resin or a rosin derivative, more preferably a terpene-phenolic resin. The PSA of the invention may also comprise mixtures of two or more tackifiers. Among the rosin derivatives, preference is given to rosin esters.

The PSA of the invention contains preferably 7 to 25 wt %, based on the total weight of the PSA, of at least one tackifier compatible with the poly(meth)acrylates. With particular preference the tackifier or tackifiers compatible with the poly(meth)acrylates is/are present at 12 to 20 wt %, based on the total weight of the PSA.

The tackifier or tackifiers in the PSA of the invention that is or are compatible with the poly(meth)acrylates is or are preferably also compatible or at least partly compatible with the synthetic rubber, more particularly with its soft block B, with the above definition of the term “compatible” being valid correspondingly. Polymer/resin compatibility is dependent on factors including the molar mass of the polymers or resins. The compatibility is better when the molar mass(es) are lower. For a given polymer it may be possible for the low molecular mass constituents of the resin molar mass distribution to be compatible with the polymer, but not those of higher molecular mass. This is an example of partial compatibility.

The weight ratio of poly(meth)acrylates to synthetic rubbers in the PSA of the invention is preferably from 1:1 to 3:1, especially from 1.8:1 to 2.2:1.

The weight ratio of tackifiers compatible with the poly(meth)acrylates to synthetic rubbers in the PSA of the invention is preferably not more than 2:1, especially not more than 1:1. This weight ratio amounts at least to preferably 1:4.

With particular preference the PSA of the invention comprises

a) 50-60 wt %, based on the total weight of the PSA, of at least one poly(meth)acrylate;
b) 20-40 wt %, based on the total weight of the PSA, of at least one synthetic rubber; and
c) 7-25 wt % of at least one tackifier compatible with the poly(meth)acrylate(s).

Preferably the synthetic rubber in the PSA of the invention is in dispersion in the poly(meth)acrylate. Accordingly, poly(meth)acrylate and synthetic rubber are preferably each homogeneous phases. The poly(meth)acrylates and synthetic rubbers present in the PSA are preferably chosen such that at 23° C. they are not miscible with one another to the point of homogeneity. At least microscopically and at least at room temperature, therefore, the PSA of the invention preferably has at least two-phase morphology. More preferably, poly(meth)acrylate(s) and synthetic rubber(s) are not homogeneously miscible with one another in a temperature range from 0° C. to 50° C., more particularly from −30° C. to 80° C., and so in these temperature ranges the PSA at least microscopically is in at least two-phase form.

Components are defined for the purposes of this specification as “not homogeneously miscible with one another” when even after intense mixing, the formation of at least two stable phases is detectable physically and/or chemically, at least microscopically, with one phase being rich in one component and the second phase being rich in the other component. The presence of negligibly small amounts of one component in the other, without opposing the development of the multiphase character, is considered insignificant in this regard. Hence the poly(meth)acrylate phase may contain small amounts of synthetic rubber, and/or the synthetic rubber phase may contain small amounts of poly(meth)acrylate component, as long as these amounts are not substantial amounts which influence phase separation.

Phase separation may be realized in particular such that discrete regions (“domains”) which are rich in synthetic rubber—in other words are essentially formed of synthetic rubber—are present in a continuous matrix which is rich in poly(meth)acrylate—in other words is essentially formed of poly(meth)acrylate.

One suitable system of analysis for a phase separation is scanning electron microscopy, for example. Alternatively, phase separation can also be detectable, for example, by the different phases having two glass transition temperatures independent of one another in dynamic scanning calorimetry (DSC). Phase separation is present according to the invention when it can clearly be shown by at least one of the analytical methods.

Additional multiphase character may also be present as a fine structure within the synthetic rubber-rich domains, with the A blocks forming one phase and the B blocks forming a second phase.

The PSA of the invention may comprise, over and above the constituents detailed so far, one or more hydrocarbon resin(s) that are incompatible with the poly(meth)acrylate. Hydrocarbon resins of this kind, which are likewise tackifiers, preferably include hydrogenated polymers of dicyclopentadiene; unhydrogenated, partially hydrogenated, selectively hydrogenated or fully hydrogenated hydrocarbon resins based on C5, C5/C9 or C9 monomer streams, and polyterpene resins based on α-pinene and/or β-pinene and/or δ-limonene. The hydrocarbon resins preferably have a DACP value of at least 0° C., very preferably of at least 20° C., and/or preferably an MMAP value of at least 40° C., very preferably of at least 60° C.

The aforementioned hydrocarbon resins may be present in the PSA either individually or in a mixture. Particularly preferred hydrocarbon resins are polyterpene resins based on α-pinene and/or β-pinene and/or δ-limonene.

The PSA of the invention is preferably foamed. Foaming may take place by means of any chemical and/or physical methods. Preferably, however, a foamed PSA of the invention is obtained by the introduction and subsequent expansion of microballoons. The microballoons are subject to the observations above.

The density of a foamed PSA of the invention is preferably 200 to 1000 kg/m³, more preferably 300 to 900 kg/m³, more particularly 400 to 800 kg/m³.

Depending on the area of application and desired properties of the PSA of the invention, it may be admixed with other components and/or additives, in each case alone or in combination with one or more further additives or components.

Thus, for example, the PSA of the invention may comprise fillers, dyes and pigments in powder and granule form, including in particular abrasive and reinforcing versions, such as chalks (CaCO₃), titanium dioxide, zinc oxides and/or carbon blacks, for example. The PSA preferably comprises one or more forms of chalk as filler, more preferably Mikrosöhl chalk (from Söhlde). In preferred fractions of up to 20 wt %, the addition of filler causes virtually no change to the technical adhesive properties (shear strength at room temperature, instantaneous peel adhesion on steel and PE). Furthermore, different organic fillers may be included. Suitable additives for the PSA of the invention further include—selected independently of other additives—non-expandable hollow polymer beads, solid polymer beads, hollow glass beads, solid glass beads, hollow ceramic beads, solid ceramic beads and/or solid carbon beads (“carbon microballoons”). The PSA of the invention may additionally comprise low-flammability fillers, for example ammonium polyphosphate; electrically conductive fillers, for example conductive carbon black, carbon fibres and/or silver-coated beads; thermally conductive materials such as, for example, boron nitride, aluminium oxide, silicon carbide; ferromagnetic additives, for example iron(III) oxides; organic renewable raw materials such as, for example, wood flour, organic and/or inorganic nanoparticles, fibres; compounding agents, ageing inhibitors, light stabilizers and/or anti-ozonants.

Plasticizers may optionally be included. Plasticizers added may be, for example, (meth)acrylate oligomers, phthalates, cyclohexanedicarboxylic esters, water-soluble plasticizers, plasticizer resins, phosphates or polyphosphates.

The addition of silicas, advantageously of precipitated silica surface-modified with dimethyldichlorosilane, may be utilized in order to adjust the thermal shear strength of the PSA.

A method for producing a PSA of the invention may initially comprise a procedure of concentrating the polyacrylate solution or dispersion resulting from polymer preparation. Concentration of the polymer may be effected in the absence of crosslinker and accelerator substances. It is, however, also possible to add not more than one of these substances to the polymer prior to concentration, with the concentration then taking place in the presence of this or these substance(s).

The synthetic rubber may be added together with the poly(meth)acrylate-compatible resin via a solids metering facility into a compounder, as for example of a planetary roll extruder. Via a side feeder, the concentrated and optionally already melted poly(meth)acrylate can be introduced into the compounder. In particular versions of the process it is also possible for concentration and compounding to take place in the same reactor. The poly(meth)acrylate-compatible resins may also be supplied via a resin melt and a further side feeder at a different position in the process, such as following introduction of synthetic rubber and poly(meth)acrylate, for example.

Further additives and/or plasticizers may likewise be supplied as solids or a melt or else a batch in combination with another formulation component. The compounder used may in particular be an extruder. In the compounder, the polymers are preferably in the melt, either since they are introduced already in the melt state or because they are heated to the melt state in the compounder. The polymers are advantageously maintained in the melt state within the compounder by heating.

If accelerator substances for the crosslinking of the poly(meth)acrylate are employed, they are preferably not added to the polymers until shortly before further processing, in particular prior to coating or other forms of shaping. The time window of the addition prior to coating is guided in particular by the pot life that is available, in other words the working time in the melt, without deleterious changes to the properties of the resulting product.

The crosslinkers, epoxides for example, and the accelerators may also both be added shortly before the further processing of the composition, in other words, advantageously, in the phase as set out above for the accelerators. For this purpose it is advantageous if crosslinkers and accelerators are introduced into the operation simultaneously at the same location, optionally in the form of an epoxide/accelerator blend. In principle it is also possible to switch the times and locations of addition for crosslinkers and accelerators in the versions set out above, so that the accelerator may be added before the crosslinker substances.

After the composition has been compounded, it may be further-processed, more particularly by coating onto a permanent or temporary carrier. A permanent carrier remains joined to the layer of adhesive composition in the application, while the temporary carrier is removed from the layer of adhesive composition in the ongoing processing operation, for example in the converting of the adhesive tape, or in the application.

Coating of the self-adhesive compositions may take place with hotmelt coating nozzles known to the skilled person or, preferably, with roll applicator mechanisms, also called coating calenders. The coating calenders may consist advantageously of two, three, four or more rolls.

Preferably at least one of the rolls is provided with an anti-adhesive roll surface. With preference all rolls of the calender that come into contact with the PSA are anti-adhesively surfaced. Employed preferably as an anti-adhesive roll surface is a steel-ceramic-silicone composite. Such roll surfaces are resistant to thermal and mechanical loads.

It has emerged as being particularly advantageous if roll surfaces are used that have a surface structure, more particularly such that the surface does not make complete contact with the layer of composition being processed, the area of contact instead being smaller by comparison with a smooth roll. Particularly favourable are structured rolls such as engraved metal rolls—engraved steel rolls, for example.

The invention further provides an adhesive tape which comprises at least one layer of such a PSA, an example being a transfer tape. They are particularly suitable for the formation of high layer thicknesses.

The preparation of a polyacrylate base polymer, which can be used by way of example, is as follows:

A reactor conventional for radical polymerizations was charged with 72.0 kg of 2-ethylhexyl acrylate, 20.0 kg of methyl acrylate, 8.0 kg of acrylic acid and 66.6 kg of acetone/isopropanol (94:6). After nitrogen gas had been passed through it for 45 minutes with stirring, the reactor was heated to 58° C. and 50 g of AIBN in solution in 500 g of acetone were added. The external heating bath was then heated to 75° C. and the reaction was carried out constantly at this external temperature. After 1 hour a further 50 g of AIBN in solution in 500 g of acetone were added, and after 4 hours the batch was diluted with 10 kg of acetone/isopropanol mixture (94:6). After 5 hours and again after 7 hours, portions of 150 g of bis(4-tert-butylcyclohexyl) peroxydicarbonate, in each case in solution in 500 g of acetone, were added for re-initiation. After a reaction time of 22 hours, the polymerization was discontinued and the batch was cooled to room temperature. The product had a solids content of 55.8% and was dried. The resulting polyacrylate had a K value of 58.9 (determined as described above), an average molecular weight of M_{w}=748 000 g/mol, a polydispersity D (M_{w}/Mₙ) of 8.9 and a glass transition temperature of T_{g}=−35.2° C.

Using this polyacrylate base polymer, it is possible to produce an adhesive tape of the invention, for example, as follows (see example 1 from DE 10 2013 215 297 A1; the adhesive tape is referred to below as K1):

In a planetary roll extruder, the synthetic rubber Kraton D1118 (styrene-butadiene-styrene triblock copolymer from Kraton Polymers, with 78 wt % diblock, block polystyrene content: 33 wt %, a portion of 1,2-linked conjugated diene in the butadiene block: 10 wt %) in granule form was melted via a solids metering facility. This was followed by addition of a microballoon paste (50% Expancel 051DU40 in Ethomeen C25, i.e. unexpanded microballoons in a tertiary amine ethoxylate, from Akzo Nobel). Via a side feeder, the polyacrylate base polymer was fed in, having been melted beforehand in a single-screw extruder, and a terpene-phenolic resin (Dertophen DT105 from DRT) was metered in. The mixture was admixed with a solution of crosslinker (Polypox R16, 15% in Reofos RDP) and of accelerator (15% Epikure 925 in Reofos RDP). Polypox R16 is a heat-induced epoxide crosslinker (pentaerythritol polyglycidyl ether, manufacturer: BASF), Epikure 925 is triethylenetetramine from Hexion. Reofos RDP is a high molecular mass phosphate ester which acts as a flame retardant (manufacturer: Great Lakes). The melt was mixed through and coated via a double-roll calender between two release films (siliconized PET film). The result was a single-layer adhesive tape having a layer thickness of, for example, 1000 μm and a density of 550 kg/m³. The composition was 48% polyacrylate, 25% Kraton D1118, 18% Dertophen DT105, 4% crosslinker/accelerator solution (crosslinker:accelerator=1:1), 5% microballoon paste (figures in wt %). In other examples, rather than Kraton D1118, Kraton D1102, likewise from Kraton Polymers, is used, this being a linear triblock copolymer based on styrene and butadiene, with a polystyrene content of 28 wt %. It is also possible, moreover, to use not only Dertophen DT105 but also Piccolyte A115, this being a polyterpene resin from the manufacturer Pinova.

The present invention, as observed above, can be employed independently of adhesive composition and liner and of the surface where bonding is to take place, provided that the pull-off force ratio according to the invention is observed. In particular, the present invention is suitable also for low-energy surfaces, these being non-polar surfaces (LSE (low surface energy) surfaces). With such surfaces, conventional application methods often fail and are unable to ensure reliable application of the adhesive diecuts.

The present invention, by contrast, enables reliable application on low-energy surfaces as well. The present invention is therefore particularly suitable for bonding of surfaces with a surface energy of 50 mN/m or less, preferably less than 40 mN/m, and more particularly less than 35 mN/m.

In applications in the motor vehicle sector in particular, it is more and more common for plastics to be used in place of metals. These plastics generally possess a low surface energy, which frequently makes it more difficult to bond on these substrates. Here, the method of the invention is particularly useful. The non-polar surfaces which can be bonded to particularly good effect with the method of the invention include, for example, those based on fluorine-containing polymers such as, for example, Teflon, silicon-organic polymers, polyolefins such as, for example, polyethylene, polypropylene, EPDM or a polypropylene-EPDM composite, ethylene-vinyl acetate copolymers, polyvinyl aromatics such as polystyrene or copolymers based on styrene (e.g. styrene-butadiene block copolymers, acrylonitrile-butadiene-styrene copolymers), polyvinyl acetate, polyacrylates such as polymethyl methacrylate, polycarbonates, polyurethanes, polyamides, polyesters such as polyethylene terephthalate, cellulose acetate, ethylcellulose, or based on polymers which comprise segments of the aforesaid polymers, or those based on a mixture of aforesaid polymers, optionally with further polymers. The phrase “based on the polymer” in this context means that predominantly the stated polymer takes on the function of the surface material. Typically the stated polymer is envisaged as the sole polymer in the surface material or at any rate to an extent of at least 50 wt %, based on the total fraction of all polymer components. Resins in this context are deemed not to be polymers. The method of the invention, however, is also suitable for bonding substrates other than polymer material, such as, for example, glass or ceramic material, metal such as, for example, stainless steel, metal oxide or combinations thereof. The materials here may be in pure form or may have been blended or filled with other materials. Additionally, the material may be recycled material or may be a functional substance for the purpose, for example, of increasing/lowering conductivities or the tactility.

The method of the invention is therefore suitable for any of a very wide variety of industrial applications, and is used preferably for interior applications, and in that case more particularly in the construction, automotive or electronics sector.

The method can be employed, for example, for adhesive bonds in the car interior sector, and in that case more particularly in doors, such as inner doors, cockpits, centre consoles, seats and other parts whose framework or individual components are to be joined to one another. It may also be employed, for example, in the bonding of shaped automotive bodywork side parts, rear view mirrors, exterior trim parts, weather strips, road signs, commercial signs, constructions, switching cabinets, shell moulds, machine parts, connection sockets or backsheet solutions for photovoltaic modules (i.e. in the solar cell industry). Furthermore, it can be used for joining to automotive clearcoat surfaces, such as, in particular, clearcoats for vehicles such as a car. The substrate to which the diecut can be applied is selected according to the particular application. For example, the diecut may be applied to film products (e.g. decorative graphics and reflective products), label material and tape carriers. Additionally, it may be applied directly to other substrates, such as to a metal plate (e.g. a vehicle panel) or a glass window, for example, to allow another substrate or object to be mounted on the plate or the window.

The method of the invention brings about a relevant improvement not only on manual application of diecuts but also in the case, in particular, of automated application, by means of a controlled robotic arm with applicator, for example.

As observed above, the method of the invention affords great advantages particularly in the context of automated application, since it is here that successful dispensing is especially important. Reliable bonding of the diecuts on the surface is particularly important for the reason that—in contrast to the situation with manual application, where the user readily sees whether the diecut has been satisfactorily adhered—there is no direct monitoring of successful dispensing or such successful dispensing can be ensured only with costly and inconvenient machine monitoring and subsequent work.

This is important particularly in the case where the parts to be bonded are large, since a large number of diecuts are applied to such parts. Since each individual one of these diecuts must be applied without error if an error-free bond of the part to be bonded is to be ensured, the production failure rate increases exponentially with the number of diecuts to be applied. Reliable application is therefore essential. Accordingly, the present method is particularly suitable for reducing the frequency of errors in the bonding of plastics parts, especially in the motor vehicle industry.

Another important factor for the automatic application of diecuts is the application rate. This is dependent on the distance between the diecuts to be applied. Because diecuts of the present invention are suitable for replacing ultrasound weld spots on plastics, typical distances between two application spots of between 50 and 200 mm, more particularly between 80 and 100 mm, are anticipated. The application time per diecut is then typically less than 5 seconds, preferably less than 2 seconds and more particularly less than 1.5 seconds.

To determine whether an adhesive tape is suitable as a diecut tape, especially for the automated application of diecuts, a test method with a defined course is required, since only in that way is there an assurance of comparability and repeatability.

The present invention therefore also provides a test method for testing the suitability of an adhesive tape as diecut tape, the diecut tape being formed of diecuts applied to a liner layer, said diecuts comprising at least one layer of adhesive composition, for applying the diecuts layer to a surface of a substrate by means of an applicator. The method here comprises, in accordance with the invention, the following steps:
a) applying a diecut to a piece of liner and pressing the diecut on the liner;
b) guiding the liner around a T-block in such a way that the diecut lies centrally on the T-block, and mechanically fastening the overhanging liner on the vertical part of the T-block;
c) controlledly pressing the T-block with the liner and the diecut located thereon, with defined force and for a defined time, onto a sample of the substrate;
d) determining the success of the transfer of the diecut from the liner to the substrate.

In the test method of the invention, the substrates used are to have the same level of cleanness as when they are typically bonded in the real-life application. In the real-life application, the components (substrates) to be bonded are frequently used directly without prior cleaning (to remove oil, for example). In that case, in the test method of the invention, the substrates used are not specially cleaned, but instead are merely freed roughly from contaminants by means of a cloth.

A preferred contact pressure time in this case has a defined but freely selectable value of between one and ten seconds. Reliable results are obtainable even for a contact pressure time of 1 sec, although a contact pressure time of 5 sec is also highly suitable.

A suitable contact pressure weight is, in particular, a weight in the range from 100 to 1000 g such as 500 g, for example.

A preferred classification of the success of transfer may take a form wherein the success of the transfer is classified as
successful, if the diecut was transferred directly and cleanly to the substrate; or
unsuccessful, if the diecut is not transferred directly, in particular if it remains on the liner, does not adhere completely on the substrate, or prevents lifting of the T-block.

If the diecut does not adhere completely on the substrate, a phenomenon may occur, for example, which is referred to as “partial lifting”, where part of the diecut is folded over because it does not adhere to the substrate, with the consequence that the overall bonding area becomes smaller because part of the diecut is lying on itself. Furthermore, this could result in a failure to comply with component tolerances. Determining the respective pull-off forces from the substrate and from the liner is preferably accomplished as follows: First of all, determination of the pull-off force from the substrate:
i) mechanically fastening a sample piece of the substrate, of defined size, on a test plate;
ii) pressing a sample piece of the adhesive tape under test, of defined size, onto the sample piece of the substrate, by means of a T-block, with defined contact pressure force and defined contact pressure time;
iii) measuring the pull-off force of the adhesive tape from the substrate in the z direction, in a tensile testing apparatus.

Subsequently, determination of the pull-off force from the liner:
iv) mechanically fastening a sample piece of the liner, of defined size, on a test plate;
v) pressing a sample piece of the adhesive tape under test, of defined size, onto the sample piece of the liner, by means of a T-block, with defined contact pressure force and defined contact pressure time;
vi) measuring the pull-off force of the adhesive tape from the liner in the z direction, in a tensile testing apparatus.

The substrate and the liner may additionally, for the purpose of mechanical fastening, be further secured against slippage by means of an adhesive tape with silicone composition.

Judicious measuring velocities in the tensile testing apparatus are 100 to 500 mm/min, more preferably 200 to 400 mm/min and more particularly 300 mm/min. The pull-off angle is 90°.

The quotient formed from the pull-off force in the z direction from the liner and the pull-off force in the z direction from the substrate is then the pull-off force ratio in the z direction.

Here again, the preferred contact pressure time is a defined but freely selectable time of between one and ten seconds. Reliable results are obtainable for a contact pressure time of just 1 sec, although a contact pressure time of 5 sec is also highly suitable. A suitable contact pressure weight is a weight in the range from 100 to 1000 g, more particularly 500 g. Preferred edge lengths of the specimen of the substrate and of the liner, respectively, are between 5 and 50 mm, more particularly between 10 and 30 mm. A specimen size of 20 mm×12 mm is especially suitable.

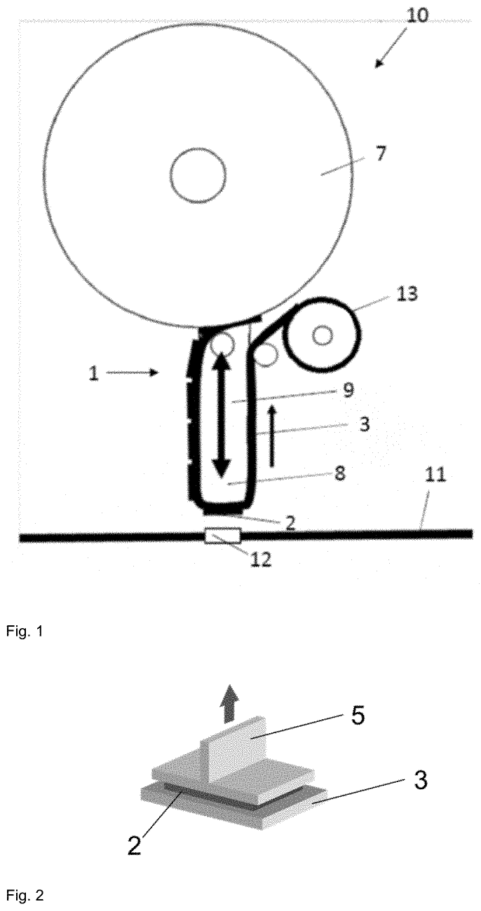

On the basis of FIG. 1 as described hereinafter, further details are given of one particularly advantageous version of the invention, without wishing thereby to impose any unnecessary limitation on the invention.

FIG. 1 shows a theoretical side view of an applicator 10 for use in the method of the invention. The applicator 10 is intended for applying diecuts 2 from a diecut tape 1 which has a liner 3. The applicator 10 has the diecut roll 7, which unwinds clockwise. The diecut tape 1 is wound up on the diecut roll 7. The diecut tape 1 has the liner 3 and also double-sidedly adhesive diecuts 2 that are disposed one after another. The diecut tape is wound up by the exposed layer of adhesive composition to give the diecut roll 7. Here, the peel adhesion of the layer of adhesive composition is made such as to enable the diecut tape 1 to be unwound easily from the diecut roll 7 by pulling on the free end of the diecut tape 1. The free end of the diecut tape 1 is guided around the stamp head 8 of the stamp 9. By driven rotation of the winding roll 13, the diecut tape 1 is pulled at the liner 3, and in this way the diecut tape 1 is positioned over the location 12 where bonding is to take place, the positioning being such that one diecut 2 is positioned exactly on the carrier head 8. The applicator 10 is then pressed onto the location 12 in a movement of the robotic arm (not shown in the drawing) on which the applicator 10 is disposed, and, because of the peel adhesion of the layer of adhesive composition on the diecut 2 to the surface 11, as the applicator 10 moves forward, the diecut 2 is transferred away from the surface of the diecut tape 1 onto the surface 11. The remaining liner 3 is wound up on the winding roll 13. As a result of the winding of the liner 3, the diecut tape 1 receives its cyclically indexed advance, and the next diecut 2 is positioned on the stamp head 8. Typically the stamp head 8 is angled sufficiently to prevent, in particular, any detachment of the diecuts in the deflection region of the stamp head 8.

A system for controlling the applicator 10 operates here as follows: a first sensor is provided, which is directed at the stamp head 8 and which registers the presence of the diecut 2 at the stamp head 8. This may be achieved, for example, by a coloured control mark; however, other recording possibilities are also conceivable. When the diecut 2 is present, the first sensor delivers a signal to the control system, which delivers a stop signal to a drive of the winding roll 13. The rotary movement of the winding roll 13 is stopped. The applicator 10 and hence the diecut 2 is pressed by a flange-connected robotic arm onto the location 12 where bonding is to take place. The applicator 10 is subsequently raised again and, coordinated by the control system, the winding roll 13 is rotated a little, so that the diecut tape 1 does not hang loosely over the retracted stamp head 8. This causes the diecut 2 to detach from the liner.

Because the diecut 2 is directed by its open adhesive side at the surface where bonding is to take place, the immediate application of the diecut 2 on the surface 11 is enabled and is promoted by the instantaneous adhesion of the diecut 2 on the surface 11.

### Experimental Section

The exemplary experiments hereinafter are intended to elucidate the invention in more detail, without any intention to impose unnecessary limitation on the invention as a result of the choice of the specified examples.

### Test Methods

Unless otherwise indicated, all measurements were carried out at 23° C. and 50% relative atmospheric humidity.

The mechanical and technical adhesive data were ascertained as follows:

### Dynamic T-Block Test

This test serves for determining the pull-off forces in the z direction of the respective adhesive tape, from the liner and from the substrate. The substrate in this case is to be used with the same cleanness with which it is typically bonded in the real-life application. Unless otherwise indicated, this determination is made under test conditions of 23° C.+/−1° C. temperature and 50%+/−5% relative humidity. The adhesive tape specimens, referred to hereinafter as diecuts, are trimmed to 20 mm×12 mm and adhered to the underside of the steel T-block. For testing the T-block to the liner, the side of the diecut that is covered by the product liner is typically investigated. The diecut in this case is protected from soiling by its own product liner. For testing the T-block to the substrate, the open side of the diecut, being the side not covered by the product liner, is typically investigated. In the latter case, prior to measurement, the diecut is covered with a suitable liner and therefore likewise protected from soiling. The liner or the substrate, respectively, is fastened mechanically to a steel test plate. The liner is additionally secured against slippage by means of an adhesive tape with silicone composition. Typically it is the inside of the liner that is tested; in other words, in the case of a wound adhesive tape comprising the liner, testing takes place typically on the side of the liner that faces the core of the adhesive tape roll. For the measurement, the liner protecting the diecut is peeled off. The T-block with the diecut is pressed for one second with a contact pressure weight of 500 g onto the liner or substrate, respectively, which is fastened on the test plate. The specimen is subsequently pulled off directly in a tensile testing apparatus from Zwick, with a pull-off speed of 300 mm/min. For this purpose, the test plate is clamped in a holding rail and the T-block is pulled off. The pull-off angle is 90°. The results of measurement are reported in N/cm² and have been averaged from three measurements.

FIG. 2 shows by way of example a simplified representation of the dynamic T-block test for determining the pull-off force in the z direction of a diecut 2 from a liner 3. It shows the time of pull-off of the T-block 5 with the diecut 2 from the liner 3.

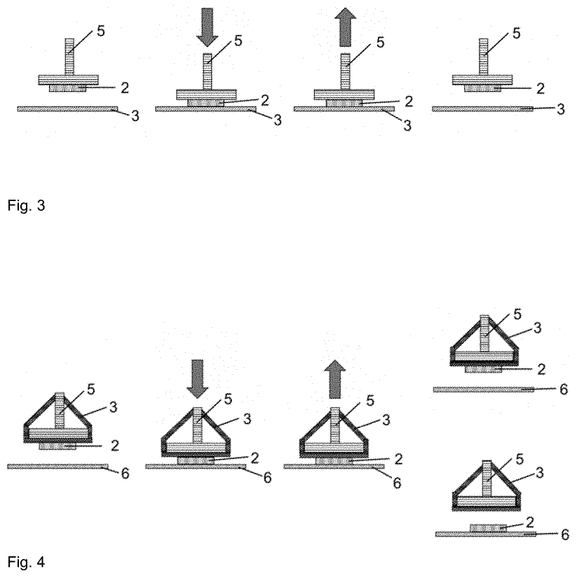

FIG. 3 shows the dynamic T-block test from FIG. 2 in the individual phases. The first picture from the left shows the T-block 5 with the diecut 2 and, separately therefrom, the liner 3. The second picture from the left shows how the T-block 5 is pressed with the diecut 2 onto the liner 3. The third picture from the left shows how the T-block 5 with the diecut 2 is pulled off from the liner 3 for the purpose of ascertaining the pull-off force. In the right-hand picture, the T-block 5 with the diecut 2 is separate from the liner 3 again. The T-block test on the substrate 6 is carried out (not shown) in analogy to the T-block test on the liner 3.

### Transfer Test

This test serves to determine successful dispensing; in other words, it ascertains whether the adhesive tape specimen, referred to hereinafter as diecut, has been properly transferred to the substrate. Unless otherwise indicated, this determination is made under test conditions of 23° C.+/−1° C. temperature and 50%+/−5% relative humidity. A diecut with a size of 20 mm×12 mm is applied to the liner specimen and pressed on with a pressure of 25 kPa for 1 s. The diecut is typically applied with its covered side on the inside of the liner used; for this purpose, the open side is first protected with a suitable liner and the product liner of the covered side is peeled off, before application to the liner which is used for the test. Thereafter the diecut is left on the liner for 24 h. The liner is guided around a T-block, so that the diecut lies centrally below the T-block. The protruding liner is fastened mechanically on the vertical part of the T-block. For the measurement, the liner protecting the diecut is peeled off. With a controlled contact pressure, the T-block is pressed for one second, with a contact pressure of 25 kPa, onto the substrate, which is fastened on a test plate. The substrate is to be used here with the same cleanness with which it is typically bonded in the real-life application. The specimen is subsequently pulled off directly in a tensile testing apparatus from Zwick, with a pull-off speed of 300 mm/min. For this purpose, the test plate is clamped in a holding rail and the T-block is pulled off. The pull-off angle is 90°.

If the diecut transfers directly and cleanly to the substrate, the dispensing operation is termed successful. If it remains on the liner, prevents lifting of the T-block or is not transferred directly, undergoing partial lifting, for example, in other words not being applied fully to the substrate, but instead sticking only partly, thereby also making it possible, for example, for the diecut to fold over, the dispensing operation is rated unsuccessful. Four transfers are carried out. The results are averaged. If the dispensing operation is successful in all cases, successful dispensing is rated as 100%; otherwise, it is rated with the corresponding fraction in percent.

FIG. 4 shows a simplified representation of the transfer test in the individual phases. The first picture from the left shows a liner 3, which is guided around a T-block 5 in such a way that the diecut 2 lies centrally below the T-block 5. The protruding liner 3 is fastened mechanically on the vertical part of the T-block 5. The substrate 6 is separate therefrom. The second picture from the left shows how the T-block 5 with the liner 3 and the diecut 2 located thereon is pressed onto the substrate 6. The third picture from the left shows how the T-block 5 is pulled off from the substrate 6. In the bottom part of the right-hand picture, the variant is shown in which the diecut 2 has been transferred directly and cleanly onto the substrate 6, allowing the dispensing operation to be termed successful. The top part of the right-hand picture shows the variant in which the diecut 2 has remained on the liner 3, meaning that the dispensing operation cannot be termed successful.

### Surface Energy

Surface energies (surface tensions) are determined according to DIN ISO 8296. This can be done using, for example, test inks from Softal. The inks are available in the range from 30 to 72 mN/m. The ink is applied at 23° C. and 50% relative humidity, with a line of ink, to the surface. If the line of ink contracts in less than 2 seconds, the measurement is repeated with ink of a lower surface energy until the 2 seconds are reached. If the ink coating remains unchanged for longer than 2 seconds, the measurement is repeated with ink of higher surface energy until the 2 seconds are reached. At that point, the figure given on the matching ink bottle corresponds to the surface energy of the substrate.

### Thickness

The thickness of a layer of adhesive composition, an adhesive tape or a carrier layer, or a liner, can be determined using commercial thickness gauges (sensor instruments) having accuracies of less than 1 μm deviation. In the present specification, the gauge used is the Mod. 2000 F precision thickness gauge, which has a circular sensor with a diameter of 10 mm (planar). The measurement force is 4 N. The value is read off 1 s after loading. If fluctuations in thickness are found, the value reported is the average value of measurements at not less than three representative sites—in other words, in particular, not including measurement at wrinkles, creases, nibs and the like. The thickness of a layer of adhesive composition can be determined in particular by determining the thickness of a section of such a layer of adhesive composition, applied to a carrier or liner, this section being of defined length and defined width, with subtraction of the thickness of a section of the carrier or liner used that has the same dimensions (the carrier or liner thickness being known or separately ascertainable).

### Glass Transition Temperature T_{g}, Melting Temperature, Softening Temperature

Glass transition points—referred to synonymously as glass transition temperatures—particularly of polymers and/or polymer blocks are reported as the result of measurements made by dynamic scanning calorimetry (DSC) in accordance with DIN 53 765, especially sections 7.1 and 8.1, but with uniform heating and cooling rates of 10 K/min in all heating and cooling steps (compare DIN 53 765; section 7.1; note 1). The initial sample mass is 20 mg. The melting temperature or softening temperature of polymers or polymer blocks is also determined in this way.

### DACP

5.0 g of test substance (the tackifier resin specimen under investigation) are weighed out into a dry sample glass and admixed with 5.0 g of xylene (isomer mixture, CAS [1330-20-7], 98.5%, Sigma-Aldrich #320579 or comparable). The test substance is dissolved at 130° C. and then cooled to 80° C. Any xylene that has escaped is made up with further xylene, to restore 5.0 g of xylene. Then 5.0 g of diacetone alcohol (4-hydroxy-4-methyl-2-pentanone, CAS [123-42-2], 99%, Aldrich # H41544 or comparable) are added. The sample glass is shaken until the test substance has completely dissolved. For this purpose, the solution is heated to 100° C. The sample glass with the resin solution is then introduced into a Chemotronic Cool cloud point instrument from Novomatics, where it is heated to 110° C. Cooling takes place with a cooling rate of 1.0 K/min. The cloud point is detected optically. A recording is made for this purpose of the temperature at which the clouding of the solution amounts to 70%. The result is reported in ° C. The lower the DACP, the higher the polarity of the test substance.

### MMAP

5.0 g of test substance (the tackifier resin specimen under investigation) are weighed out into a dry sample glass and admixed with 10 ml of dry aniline (CAS [62-53-3], 99.5%, Sigma-Aldrich #51788 or comparable) and 5 ml of dry methylcyclohexane (CAS [108-87-2], 99%, Sigma-Aldrich #300306 or comparable). The sample glass is shaken until the test substance has completely dissolved. For this purpose, the solution is heated to 100° C. The sample glass with the resin solution is then introduced into a Chemotronic Cool cloud point instrument from Novomatics, where it is heated to 110° C. Cooling takes place with a cooling rate of 1.0 K/min. The cloud point is detected optically. A recording is made for this purpose of the temperature at which the clouding of the solution amounts to 70%. The result is reported in ° C. The lower the MMAP, the higher the aromaticity of the test substance.

Adhesive tapes, liners and substrates used were as follows:

### Adhesive Tapes:

TABLE 2
Adhesive tapes

| | | Thickness | Trade | |
|---|---|---|---|---|
| Sample | Adhesive tape | [μm] | name | Manufacturer |
| K1 | viscoelastic acrylate | 1100 | | |
| | foam (as defined | | | |
| | above) | | | |
| K2 | viscoelastic, SBC- | 1100 | | |
| | based foam (as defined | | | |
| | above) | | | |
| K3 | three-layer adhesive | 1100 | 3M | 3M |
| | tape with a density of | | Acrylic | Deutschland |
| | about 592 kg/m³, with | | Plus | GmbH |
| | acrylate foam core | | EX4511 | |
| | containing | | | |
| | microballoons, and on | | | |
| | each of the two sides | | | |
| | an around 50 μm layer | | | |
| | of a synthetic rubber | | | |
| | adhesive composition | | | |
| | based on SIS and | | | |
| | tackifier resin | | | |
| K4 | viscoelastic acrylate | 1200 | 3M GT | 3M |
| | foam with a density of | | 6012 | Deutschland |
| | about 700 kg/m³, | | | GmbH |
| | produced by UV | | | |
| | polymerization and | | | |
| | containing hollow | | | |
| | glass spheres | | | |
| K5 | three-layer adhesive | 1100 | 3M PX | 3M |
| | tape with a density of | | 5011 | Deutschland |
| | 688 kg/m³, with acrylate | | | GmbH |
| | foam core containing | | | |
| | hollow glass spheres, | | | |
| | and on each of the two | | | |
| | sides an around 50 μm | | | |
| | layer of an acrylate | | | |
| | adhesive composition | | | |

### Liners:

TABLE 3
Liners

| Sample | Material | Source |
|---|---|---|
| L1 | unsiliconized polyolefin | tesa SE |
| | liner 120 μm thick with | |
| | HDPE core and 2 outer | |
| | LDPE layers | |
| L2 | double-sidedly siliconized | tesa SE |
| | PET liner with a thickness | |
| | of 75 μm | |
| L3 | double-sidedly siliconized | liner from |
| | polyethylene film | product |
| | | 3M EX4511 |
| L4 | unsiliconized polyethylene | liner from |
| | liner | product |
| | | 3M GT 6012 |
| L5 | double-sidedly siliconized | liner from |
| | polyethylene film | product |
| | | 3M PX 5011 |

Substrates employed were polypropylene (PP), acrylonitrile-butadiene-styrene copolymer (ABS) and acrylonitrile-butadiene-styrene copolymer (tesa ABS). The polypropylene substrate (PP) contains 20 wt % of talc and has a surface energy of 32 mN/m. The acrylonitrile-butadiene-styrene copolymer (ABS) contains 20 wt % of glass fibres and has a surface energy of 40 mN/m. The acrylonitrile-butadiene-styrene copolymer (tesa ABS) contains no fillers and has a surface energy of 36 mN/m.

### Test Series, Substrate 1—Polypropylene (PP)

In the first test series, the pull-off forces in the z direction were ascertained for the respective adhesive tapes on the various liners and also on PP. The values are reproduced in table 4.1.

TABLE 4.1
Pull-off forces in z direction, PP

| | | Pull-off force in z direction [N/cm²] | | | | | |
|---|---|---|---|---|---|---|---|
| | | for liner/substrate (PP) | | | | | |
| | | Liner | Liner | Liner | Liner | Liner | |
| | | L3 | L4 | L2 | L1 | L5 | PP |
| Adhesive | K1 | 0.5 | 8.8 | 0.6 | 7.9 | 1.0 | 29.0 |
| tape | K2 | 0.6 | 18.1 | 1.6 | 16.3 | 1.5 | 76.0 |
| | K3 | 0.7 | 16.0 | 2.8 | 23.0 | 3.2 | 68.0 |
| | K4 | 1.5 | 3.4 | 1.6 | 4.5 | 2.5 | 15.9 |
| | K5 | 1.3 | 17.4 | 2.1 | 13.1 | 2.8 | 60.8 |

From the values in table 4.1, a determination was made of the pull-off force ratios of the various liners with respect to PP. These ratios are reproduced in table 4.2.

TABLE 4.2
Pull-off force ratios in z direction, liner/PP

| | | Pull-off force ratio in z direction for liner/substrate (PP) | | | | | |
|---|---|---|---|---|---|---|---|
| | | Liner | Liner | Liner | Liner | Liner | |
| | | L3 | L4 | L2 | L1 | L5 | PP |
| Adhesive | K1 | 0.02 | 0.30 | 0.02 | 0.27 | 0.04 | 1.00 |
| comp. | K2 | 0.01 | 0.24 | 0.02 | 0.21 | 0.02 | 1.00 |
| | K3 | 0.01 | 0.24 | 0.04 | 0.34 | 0.05 | 1.00 |
| | K4 | 0.09 | 0.22 | 0.10 | 0.28 | 0.15 | 1.00 |
| | K5 | 0.02 | 0.29 | 0.03 | 0.21 | 0.05 | 1.00 |

The successful dispensing onto PP was ascertained by the transfer test. The results are reproduced in table 4.3:

TABLE 4.3
Successful dispensing, liner on PP

| | | Successful dispensing from the liner onto PP | | | | |
|---|---|---|---|---|---|---|
| | | Liner | Liner | Liner | Liner | Liner |
| | | L3 | L4 | L2 | L1 | L5 |
| Adhesive | K1 | 100% | 0% | 100% | 0% | 100% |
| comp. | K2 | 100% | 0% | 100% | 0% | 100% |
| | K3 | 100% | 0% | 100% | 0% | 100% |
| | K4 | 100% | 0% | 100% | 0% | 75% |
| | K5 | 100% | 0% | 100% | 0% | 100% |

### Test Series, Substrate 2—Acrylonitrile-Butadiene-Styrene Copolymer (ABS)

In the second test series, the pull-off forces in the z direction were ascertained for the respective adhesive tapes on the various liners and also on ABS. The values are reproduced in table 5.1.

TABLE 5.1
Pull-off forces in z direction, ABS

| | | Pull-off force in z direction [N/cm²] for liner/substrate | | | | | |
|---|---|---|---|---|---|---|---|
| | | Liner | Liner | Liner | Liner | Liner | |
| | | L3 | L4 | L2 | L1 | L5 | ABS |
| Adhesive | K1 | 0.5 | 8.8 | 0.6 | 7.9 | 1.0 | 61.4 |
| comp. | K2 | 0.6 | 18.1 | 1.6 | 16.3 | 1.5 | 67.0 |
| | K3 | 0.7 | 16.0 | 2.8 | 23.0 | 3.2 | 59.5 |
| | K4 | 1.5 | 3.4 | 1.6 | 4.5 | 2.5 | 34.0 |
| | K5 | 1.3 | 17.4 | 2.1 | 13.1 | 2.8 | 46.2 |

From the values in table 5.1, a determination was made of the pull-off force ratios of the various liners with respect to ABS. These ratios are reproduced in table 5.2.

TABLE 5.2
Pull-off force ratios in z direction, liner/ABS

| | | Pull-off force ratio in z direction for liner/substrate | | | | | |
|---|---|---|---|---|---|---|---|
| | | Liner | Liner | Liner | Liner | Liner | |
| | | L3 | L4 | L2 | L1 | L5 | ABS |
| Adhesive | K1 | 0.01 | 0.14 | 0.01 | 0.13 | 0.02 | 1.00 |
| comp. | K2 | 0.01 | 0.27 | 0.02 | 0.24 | 0.02 | 1.00 |
| | K3 | 0.01 | 0.27 | 0.05 | 0.39 | 0.05 | 1.00 |
| | K4 | 0.04 | 0.10 | 0.05 | 0.13 | 0.07 | 1.00 |
| | K5 | 0.03 | 0.38 | 0.05 | 0.28 | 0.06 | 1.00 |

The successful dispensing onto ABS was ascertained by the transfer test. The results are reproduced in table 5.3:

TABLE 5.3
Successful dispensing, liner on ABS

| | | Successful dispensing from the liner onto ABS | | | | |
|---|---|---|---|---|---|---|
| | | Liner | Liner | Liner | Liner | Liner |
| | | L3 | L4 | L2 | L1 | L5 |
| Adhesive | K1 | 100% | 75% | 100% | 75% | 100% |
| comp. | K2 | 100% | 0% | 100% | 0% | 100% |
| | K3 | 100% | 0% | 100% | 0% | 100% |
| | K4 | 100% | 100% | 100% | 75% | 100% |
| | K5 | 100% | 0% | 100% | 0% | 100% |

Test series, substrate 3—Acrylonitrile-Butadiene-Styrene Copolymer (Tesa ABS)

In the third test series, the pull-off forces in the z direction were ascertained for the respective adhesive tapes on the various liners and also on tesa ABS. The values are reproduced in table 6.1.

TABLE 6.1
Pull-off forces in z direction, tesa ABS

| | | Pull-off force in z direction [N/cm²] for liner/substrate | | | | | |
|---|---|---|---|---|---|---|---|
| | | Liner | Liner | Liner | Liner | Liner | |
| | | L3 | L4 | L2 | L1 | L5 | tesa ABS |
| Adhesive | K1 | 0.5 | 8.8 | 0.6 | 7.9 | 1.0 | 86.3 |
| comp. | K2 | 0.6 | 18.1 | 1.6 | 16.3 | 1.5 | 90.9 |
| | K3 | 0.7 | 16.0 | 2.8 | 23.0 | 3.2 | 41.0 |
| | K4 | 1.5 | 3.4 | 1.6 | 4.5 | 2.5 | 74.3 |
| | K5 | 1.3 | 17.4 | 2.1 | 13.1 | 2.8 | 64.1 |

From the values in table 6.1, a determination was made of the pull-off force ratios of the various liners with respect to tesa ABS. These ratios are reproduced in table 6.2.

TABLE 6.2
Pull-off force ratios in z direction, liner/tesa ABS

| | | Pull-off force ratio in z direction for liner/substrate | | | | | |
|---|---|---|---|---|---|---|---|
| | | Liner | Liner | Liner | Liner | Liner | |
| | | L3 | L4 | L2 | L1 | L5 | tesa ABS |
| Adhesive | K1 | 0.01 | 0.10 | 0.01 | 0.09 | 0.01 | 1.00 |
| comp. | K2 | 0.01 | 0.20 | 0.02 | 0.18 | 0.02 | 1.00 |
| | K3 | 0.02 | 0.39 | 0.07 | 0.56 | 0.08 | 1.00 |
| | K4 | 0.02 | 0.05 | 0.02 | 0.06 | 0.03 | 1.00 |
| | K5 | 0.02 | 0.27 | 0.03 | 0.20 | 0.04 | 1.00 |

The successful dispensing onto tesa ABS was ascertained by the transfer test. The results are reproduced in table 6.3:

TABLE 6.3
Successful dispensing, liner on tesa ABS

| | | Successful dispensing from the liner onto tesa ABS | | | | |
|---|---|---|---|---|---|---|
| | | Liner | Liner | Liner | Liner | Liner |
| | | L3 | L4 | L2 | L1 | L5 |
| Adhesive | K1 | 100% | 100% | 100% | 100% | 100% |
| comp. | K2 | 100% | 0% | 100% | 75% | 100% |
| | K3 | 100% | 0% | 100% | 0% | 100% |
| | K4 | 100% | 100% | 100% | 100% | 100% |
| | K5 | 100% | 0% | 100% | 0% | 100% |

Looking at the measurement values for the pull-off values (tables 4.1, 5.1 and 6.1), there is no evident trend. The data show that the same adhesive tape on different liners exhibits different pull-off forces in the z direction. It is possible to observe, moreover, that the adhesive tapes on the same liner likewise show different pull-off forces in the z direction. No prediction about successful dispensing can be made on the basis of these data.

After that, the ratio of the pull-off force in the z direction from the liner to the pull-off force in the z direction from the substrate was formed (tables 4.2, 5.2 and 6.2). It is apparent that, although the individual adhesive tapes exhibit different initial adhesion on the substrate and on the liner, there are trends. Hence the various adhesive tapes exhibit values in a comparable order of magnitude in terms of the pull-off force ratio with respect to the substrate.

A comparison of the data for the pull-off force ratio with the data for successful dispensing (tables 4.3, 5.3 and 6.3) shows that sufficiently successful dispensing (to an extent at least of 75% or else of 100%) occurs when the pull-off force ratio is below a certain value, namely at most 0.18.

Surprisingly it emerges that successful dispensing can be predicted by means of the pull-off force ratios of the adhesive tape from the liner to the substrate. Taking account of this when selecting adhesive tape and liner in relation to the adhesion on the substrate, therefore, it is possible to ensure a stable application procedure.

1. A method for transferring one or more diecuts from a liner layer to a surface, the method comprising:
transferring one or more diecuts from the liner layer to the surface by means of an applicator, wherein a ratio of a pull-off force of the one or more diecuts from the liner layer in the z direction to a pull-off force of the one or more diecuts from the surface in the z direction is less than or equal to about 0.18.

2. The method of claim 1, wherein the applicator comprises:
(i) a stamp with a stamp head;
(ii) a diecut roll which constitutes a diecut tape which is formed of the one ore more diecuts applied to the liner layer, the one or more diecuts comprising at least one layer of pressure-sensitive adhesive composition; and
(iii) a liner winding roll,
where, in the method, the diecut tape runs over the stamp head of the stamp, the diecut tape being stopped when one diecut of the one or more diecuts is positioned over the stamp head, and the stamp then adhering the one diecut to the surface in an up-and-down movement.

3. The method of claim 1, wherein the ratio of pull-off force of the one or more diecuts from the liner layer in the z direction to pull-off force of the one or more diecuts from the surface in the z direction is less than or equal to about 0.15.

4. The method of claim 1, wherein a control system, which is signal-conductingly connected to a first sensor, which with a scanning region is directed at the stamp head and registers the presence of one diecut of the one or more diecuts at the stamp head, and to a robotic arm on which the applicator is arranged, stops the winding roll when one diecut of the one or more diecuts is registered and then drives a down movement of the robotic arm with the applicator, for adhering the one diecut to the surface, and a subsequent up movement of the robotic arm with the applicator, for return to the original position.

5. The method of claim 4, wherein after the one diecut has been adhered to the surface, the diecut tape is cycled onward by another diecut.

6. The method of claim 5, wherein the control system actuates the robotic arm and moves the stamp head into a first position over the surface, and adheres the one diecut in a first surface position, and, after the one diecut has been adhered, actuates the robotic arm and moves the stamp head, during the onward cycling of the diecut tape into a second position over the surface, where it drives a down movement and a subsequent up movement of the robotic arm with the applicator.

7. The method of claim 2, wherein the stamp head is resiliently mounted and the stamp head is assigned at least one pressure sensor which detects the contact pressure force of the one or more diecuts on the surface.

8. The method of claim 2, wherein the at least one layer of adhesive composition consists of a self-adhesive composition that is based on vinyl aromatic block copolymer and comprises tackifier resin, the vinyl aromatic block copolymer typically comprising
at least one polymer block A, formed predominantly by polymerization of vinyl aromatics, and
at the same time at least one polymer block B, formed predominantly by polymerization of conjugated dienes, the fraction of 1,2-linked conjugated diene in the B block being less than 30 wt %.

9. The method of claim 8, wherein the at least one layer of adhesive composition comprises poly(meth)acrylate and also optionally synthetic rubber and/or at least one tackifier resin compatible with the poly(meth)acrylate(s).

10. The method of claim 2, wherein the layer of adhesive composition is crosslinked, by irradiation by UV or electrons, or by thermal crosslinker.

11. The method of claim 2, wherein the layer of adhesive composition is foamed, with microballoons.

12. The method of claim 1, wherein an adhesive tape of which the one or more diecuts are formed is an adhesive tape having an acrylate-based viscoelastic foam bearing optionally on both sides an applied layer of pressure-sensitive adhesive composition.

13. The method of claim 2, wherein the layer of adhesive composition has a thickness of 25 to 5000 μm.

14. The method of claim 2, wherein the diecut tape is a double-sided adhesive tape.

15. The method of claim 1, wherein a surface of the one or more diecuts bonded to the surface have a surface energy of 50 mN/m or less.

16. The method of claim 1, further comprising:
bonding plastics parts together via the one or more diecuts, wherein the plastic parts are parts of a motor vehicle.

17. The method of claim 16, further comprising:
reducing a frequency of errors in the bonding of plastics parts with the one or more diecuts.

18. The method of claim 1, further comprising:
automatically applying the one or more diecuts to the surface.

19. A method for selecting an adhesive tape as diecut tape, the diecut tape being formed of diecuts applied to a liner layer, said diecuts comprising at least one layer of adhesive composition, for a method for transferring the diecuts from the liner layer to a surface of a substrate by means of the applicator of claim 1, the method comprising:
a) applying a diecut to a piece of liner and pressing the diecut on the liner;
b) guiding the liner around a T-block in such a way that the diecut lies centrally on the T-block, and mechanically fastening the overhanging liner on the vertical part of the T-block;
c) controlledly pressing the T-block with the liner and the diecut located thereon, with defined force and for a defined time, onto a sample of the substrate;
d) determining the success of the transfer of the diecut from the liner to the substrate.

20. The method of claim 19, wherein the transfer is classed as
successful, if the diecut was transferred directly and cleanly to the substrate; or
unsuccessful, if the diecut is not transferred directly, in particular if it remains on the liner or prevents lifting of the T-block.

21. The method claim 20, wherein the success of the transfer is predicted by ascertaining the pull-off force ratio of the pull-off force in the z direction from the liner to the pull-off force in the z direction from the substrate, by means of the following steps:
i) mechanically fastening a sample piece of the substrate, of defined size, on a test plate;
ii) pressing a sample piece of the adhesive tape under test, of defined size, onto the sample piece of the substrate, by means of a T-block, with defined contact pressure force and defined contact pressure time;
iii) measuring the pull-off force of the adhesive tape from the substrate in the z direction, in a tensile testing apparatus;
iv) mechanically fastening a sample piece of the liner, of defined size, on a test plate;
v) pressing a sample piece of the adhesive tape under test, of defined size, onto the sample piece of the liner, by means of a T-block, with defined contact pressure force and defined contact pressure time;
vi) measuring the pull-off force of the adhesive tape from the liner in the z direction, in a tensile testing apparatus;
vii) forming the quotient of pull-off force of the adhesive tape from the liner in the z direction to pull-off force of the adhesive tape from the substrate in the z direction.
